(19) United States
(12) Patent Application Publication
(10) Pub. No.: US 2019/0023050 A1
(43) Pub. Date: Jan. 24, 2019

(54) PRINTING PLATE, PRINTING METHOD, AND METHOD FOR MANUFACTURING PRINTING PLATE

(71) Applicants: FUJIFILM Corporation, Tokyo (JP); National Institute of Advanced Industrial Science and Technology, Tokyo (JP)

(72) Inventors: Yasuyuki KUSAKA, Tsukuba-shi (JP); Kouki TAKAHASHI, Kanagawa (JP)

(73) Assignees: FUJIFILM Corporation, Tokyo (JP); National Institute of Advanced Industrial Science and Technology, Tokyo (JP)

(21) Appl. No.: 16/126,711

(22) Filed: Sep. 10, 2018

Related U.S. Application Data
(63) Continuation of application No. PCT/JP2017/010388, filed on Mar. 15, 2017.

(30) Foreign Application Priority Data
Mar. 23, 2016 (JP) 2016-058293

(51) Int. Cl. B41N 1/12; B41C 1/00; B41M 1/32

(52) U.S. Cl. CPC B41N 1/12; B41M 1/32; B41C 1/003

(57) ABSTRACT

Provided are a printing plate and a printing method that allow for high-resolution printing and efficient use of printing ink. The printing plate has an image area and a non-image area. The image area of the printing plate is a recessed area formed by a layer containing silicone rubber. The non-image area is a raised area formed by a layer containing a fluorine compound on a surface of the layer containing silicone rubber. The height difference between a surface of the image area and a surface of the non-image area of the printing plate is from more than 0.1 μm to 10 μm. The printing method includes an ink-applying step of applying a printing ink to an image area of a printing plate and a transfer step of transferring the printing ink from the image area to a substrate. A method for manufacturing a printing plate has the steps of forming a second layer containing silicone rubber in a region that becomes a non-image area on a first layer containing silicone rubber to obtain a layer containing silicone rubber; and forming the layer containing the fluorine compound on a surface of the second layer containing silicone rubber.

### CROSS-REFERENCE TO RELATED APPLICATIONS

This application is a Continuation of PCT International Application No. PCT/JP2017/010388 filed on Mar. 15, 2017, which claims priority under 35 U.S.C. § 119(a) to Japanese Patent Application No. 2016-058293 filed on Mar. 23, 2016. The above application is hereby expressly incorporated by reference, in its entirety, into the present application.

### BACKGROUND OF THE INVENTION

### 1. Field of the Invention

The present invention relates to printing plates for use in the formation of components such as wiring patterns, printing methods using such printing plates, and methods for manufacturing such printing plates. In particular, the invention relates to a printing plate that can be used for the formation of a high-resolution pattern, a printing method using such a printing plate, and a method for manufacturing such a printing plate.

### 2. Description of the Related Art

Nowadays, printing is used not only for the formation of characters and photographs, but also for the formation of wiring boards and other components. Attempts to manufacture electronic devices by printing technology using functional materials in the form of ink are expected to provide a new approach to form passive elements and active electronic elements as well as metal lines. The technology known as printed electronics has attracted attention because its process can be performed at normal pressure and relatively low temperature and thus allows the manufacture of electronic devices with low energy in a simple manner.

JP2011-11374A discloses an intaglio printing plate having a recessed image area and a non-image area formed on a printing substrate. The image area is recessed relative to the non-image area. The image area and the non-image area in JP2011-11374A are formed on a main surface of the substrate. The image area has a solvent-retaining layer and a resin layer. The resin layer has an opposing surface opposing the main surface of the substrate. The solvent-retaining layer is disposed between the substrate and the resin layer. The solvent-retaining layer has a contact surface in surface contact with the opposing surface of the resin layer. The solvent-retaining layer and the resin layer are stacked on top of each other on the inner surface of the recessed image area. The non-image area is formed by a metal film deposited on the substrate. The image area is an area from which ink is transferred to a printing medium during printing. The non-image area is an area from which no ink is transferred to a printing medium during printing.

JP2007-164070A discloses an intaglio transfer plate for use in an intaglio transfer process including filling an intaglio transfer plate with a liquid transfer material and, after the transfer material cures or solidifies, striping the transfer material to form a desired object made of the transfer material on the receiving side. At least a portion of the surface layer of the plate is formed of a material with low critical surface tension or is formed by the segregation of a material with the ability to decrease critical surface tension.

The material with low critical surface tension is a block copolymer or graft copolymer containing a fluorocarbon resin or a silicone resin and can be made photocurable.

The material with the ability to decrease critical surface tension is a silicone resin additive or a fluorocarbon resin additive. The portion of the surface layer of the plate formed by the precipitation of that material is obtained by adding a silicone resin additive or a fluorocarbon resin additive to a curable material for forming that portion in a liquid state, forming the surface layer, and performing heating treatment before curing.

JP2005-305670A discloses an intaglio plate having on a plate substrate a plate pattern composed of a recessed area corresponding to an image area and a bank area corresponding to a non-image area. The bank area is elastically deformable and has its top surface partially or completely formed of an ink-repellent material that repels ink. The intaglio plate in JP2005-305670A is used to form an image on a hard substrate like a glass substrate by direct printing.

### SUMMARY OF THE INVENTION

The non-image area in JP2011-11374A is formed by a metal film; therefore, the surface is formed of a metal. The resin layer in the recessed area is formed of silicone rubber; therefore, the surface layer in the recessed area is formed of silicone rubber.

The surface of the non-image area in JP2007-164070A is not liquid-repellent, and the printing method is performed by applying ink over the entire surface of the plate. The surface of the non-image area in JP2005-305670A is formed of silicone, rather than a fluorine-containing material.

All the intaglio plates in JP2011-11374A, JP2007-164070A, and JP2005-305670A have a problem in that ink overflows from the image area, that is, the recessed area, because the configurations described above do not impart sufficient liquid repellency to the non-image area. Thus, a high-resolution pattern cannot be formed.

An object of the present invention is to solve the foregoing problem with the related art and provide a printing plate, a printing method, and a method for manufacturing a printing plate that allow the formation of a high-resolution pattern.

To achieve the foregoing object, the present invention provides a printing plate having an image area and a non-image area. The image area is a recessed area formed by a layer containing silicone rubber. The non-image area is a raised area formed by a layer containing a fluorine compound on a surface of the layer containing silicone rubber. The height difference between a surface of the image area and a surface of the non-image area is from more than 0.1 μm to 10 μm.

The receding contact angle of a printing ink on the non-image area is preferably larger than the advancing contact angle of the printing ink on the image area.

Preferably, a printing ink contains a solvent, and the rate of absorption of the solvent into the image area is higher than the rate of absorption of the solvent into the non-image area.

The printing ink preferably has a viscosity of from 1 mPa·s to 30 mPa·s.

The printing plate is preferably used for manufacture of an electronic device and is also preferably used for formation of a wiring pattern or an electrode.

The present invention provides a printing method using a printing plate having an image area and a non-image area. The image area is a recessed area formed by a layer containing silicone rubber. The non-image area is a raised area formed by a layer containing a fluorine compound on a surface of the layer containing silicone rubber. The height difference between a surface of the image area and a surface of the non-image area is from more than 0.1 μm to 10 μm. This printing method has an ink-applying step of applying a printing ink to the image area and a transfer step of transferring the printing ink from the image area to a substrate.

The ink-applying step preferably includes applying the printing ink to the image area by an inkjet process. The ink-applying step preferably includes changing the amount of printing ink applied to the image area.

The present invention provides a method for manufacturing a printing plate having an image area and a non-image area. The image area is a recessed area formed by a layer containing silicone rubber. The non-image area is a raised area formed by a layer containing a fluorine compound on a surface of the layer containing silicone rubber. The height difference between a surface of the image area and a surface of the non-image area is from more than 0.1 μm to 10 μm. This method has the steps of forming a second layer containing silicone rubber in a region that becomes the non-image area on a first layer containing silicone rubber to obtain the layer containing silicone rubber; and forming the layer containing the fluorine compound on a surface of the second layer containing silicone rubber.

The present invention provides a method for manufacturing a printing plate having an image area and a non-image area. The image area is a recessed area formed by a layer containing silicone rubber. The non-image area is a raised area formed by a layer containing a fluorine compound on a surface of the layer containing silicone rubber. The height difference between a surface of the image area and a surface of the non-image area is from more than 0.1 μm to 10 μm. This method has the steps of forming the layer containing the fluorine compound on the layer containing silicone rubber; and removing the layer containing the fluorine compound and the layer containing silicone rubber from a region that becomes the image area.

The present invention provides a method for manufacturing a printing plate having an image area and a non-image area. The image area is a recessed area formed by a layer containing silicone rubber. The non-image area is a raised area formed by a layer containing a fluorine compound on a surface of the layer containing silicone rubber. The height difference between a surface of the image area and a surface of the non-image area is from more than 0.1 μm to 10 μm. This method has the steps of forming a layer containing a fluorosurfactant and a silicone resin on the layer containing silicone rubber; and removing the layer containing the fluorosurfactant and the silicone resin from a region that becomes the image area.

The present invention provides a method for manufacturing a printing plate having an image area and a non-image area. The image area is a recessed area formed by a layer containing silicone rubber. The non-image area is a raised area formed by a layer containing a fluorine compound on a surface of the layer containing silicone rubber. The height difference between a surface of the image area and a surface of the non-image area is from more than 0.1 μm to 10 μm. This method has the steps of forming the layer containing silicone rubber on a support having a raised pattern for forming the recessed area of the printing plate; stripping the layer containing silicone rubber from the support; and forming the layer containing the fluorine compound on a surface of a region of the layer containing silicone rubber, the region being a region that becomes the non-image area.

The printing plate according to the present invention allows the formation of a high-resolution pattern. In addition, the printing method allows the formation of a high-resolution pattern.

The methods for manufacturing a printing plate can be used to obtain a printing plate that allows the formation of a high-resolution pattern.

### BRIEF DESCRIPTION OF THE DRAWINGS

FIG. 1 is a schematic view of an example printing apparatus for use in printing with a printing plate according to an embodiment of the present invention;

FIG. 2 is a schematic view of an image-recording unit of the printing apparatus according to the embodiment of the present invention;

FIG. 3 is a plan view of a nozzle array of an inkjet head;

FIG. 4 is a plan view of another example nozzle array of an inkjet head;

FIG. 5 is a schematic view of an ink supply mechanism of the printing apparatus according to the embodiment of the present invention;

FIG. 6 is a schematic plan view of the printing plate according to the embodiment of the present invention;

FIG. 7 is a schematic sectional view of an example printing plate according to the embodiment of the present invention;

FIG. 8 is a schematic sectional view of another example printing plate according to the embodiment of the present invention;

FIG. 9 is a schematic plan view of an example printing pattern of the printing plate according to the embodiment of the present invention;

FIG. 10 is a schematic view of example thin-film transistors formed using the printing plate according to the embodiment of the present invention;

FIG. 11 is a schematic sectional view of a first example process of manufacturing the printing plate according to the embodiment of the present invention;

FIG. 12 is a schematic sectional view of the first example process of manufacturing the printing plate according to the embodiment of the present invention;

FIG. 13 is a schematic sectional view of the first example process of manufacturing the printing plate according to the embodiment of the present invention;

FIG. 14 is a schematic sectional view of the first example process of manufacturing the printing plate according to the embodiment of the present invention;

FIG. 15 is a schematic sectional view of the first example process of manufacturing the printing plate according to the embodiment of the present invention;

FIG. 16 is a schematic sectional view of a second example process of manufacturing the printing plate according to the embodiment of the present invention;

FIG. 17 is a schematic sectional view of the second example process of manufacturing the printing plate according to the embodiment of the present invention;

FIG. 18 is a schematic sectional view of a third example process of manufacturing the printing plate according to the embodiment of the present invention;

FIG. 19 is a schematic sectional view of the third example process of manufacturing the printing plate according to the embodiment of the present invention;

FIG. 20 is a schematic sectional view of the third example process of manufacturing the printing plate according to the embodiment of the present invention;

FIG. 21 is a schematic sectional view of the third example process of manufacturing the printing plate according to the embodiment of the present invention;

FIG. 22 is a schematic sectional view of a fourth example process of manufacturing the printing plate according to the embodiment of the present invention;

FIG. 23 is a schematic sectional view of the fourth example process of manufacturing the printing plate according to the embodiment of the present invention;

FIG. 24 is a schematic sectional view of the fourth example process of manufacturing the printing plate according to the embodiment of the present invention;

FIG. 25 is a schematic sectional view of the fourth example process of manufacturing the printing plate according to the embodiment of the present invention;

FIG. 26 is a schematic sectional view of a fifth example process of manufacturing the printing plate according to the embodiment of the present invention;

FIG. 27 is a schematic sectional view of the fifth example process of manufacturing the printing plate according to the embodiment of the present invention;

FIG. 28 is a schematic sectional view of the fifth example process of manufacturing the printing plate according to the embodiment of the present invention;

FIG. 29 is a schematic sectional view of the fifth example process of manufacturing the printing plate according to the embodiment of the present invention;

FIG. 30 is a schematic sectional view of a sixth example process of manufacturing the printing plate according to the embodiment of the present invention;

FIG. 31 is a schematic sectional view of the sixth example process of manufacturing the printing plate according to the embodiment of the present invention;

FIG. 32 is a schematic sectional view of the sixth example process of manufacturing the printing plate according to the embodiment of the present invention;

FIG. 33 is a schematic sectional view of the sixth example process of manufacturing the printing plate according to the embodiment of the present invention;

FIG. 34 is a schematic sectional view of the sixth example process of manufacturing the printing plate according to the embodiment of the present invention;

FIG. 35 is a schematic sectional view of a seventh example process of manufacturing the printing plate according to the embodiment of the present invention;

FIG. 36 is a schematic sectional view of the seventh example process of manufacturing the printing plate according to the embodiment of the present invention;

FIG. 37 is a schematic sectional view of the seventh example process of manufacturing the printing plate according to the embodiment of the present invention;

FIG. 38 is a schematic sectional view of the seventh example process of manufacturing the printing plate according to the embodiment of the present invention;

FIG. 39 is a schematic sectional view of the seventh example process of manufacturing the printing plate according to the embodiment of the present invention;

FIG. 40 is a schematic sectional view of an eighth example process of manufacturing the printing plate according to the embodiment of the present invention;

FIG. 41 is a schematic sectional view of the eighth example process of manufacturing the printing plate according to the embodiment of the present invention;

FIG. 42 is a schematic sectional view of the eighth example process of manufacturing the printing plate according to the embodiment of the present invention;

FIG. 43 is a schematic sectional view of a ninth example process of manufacturing the printing plate according to the embodiment of the present invention;

FIG. 44 is a schematic sectional view of the ninth example process of manufacturing the printing plate according to the embodiment of the present invention;

FIG. 45 is a schematic sectional view of the ninth example process of manufacturing the printing plate according to the embodiment of the present invention;

FIG. 46 is a schematic sectional view of the ninth example process of manufacturing the printing plate according to the embodiment of the present invention;

FIG. 47 is a schematic sectional view of the ninth example process of manufacturing the printing plate according to the embodiment of the present invention;

FIG. 48 is a schematic sectional view of the ninth example process of manufacturing the printing plate according to the embodiment of the present invention;

FIG. 49 is a schematic sectional view of a tenth example process of manufacturing the printing plate according to the embodiment of the present invention;

FIG. 50 is a schematic sectional view of the tenth example process of manufacturing the printing plate according to the embodiment of the present invention;

FIG. 51 is a schematic sectional view of the tenth example process of manufacturing the printing plate according to the embodiment of the present invention;

FIG. 52 is a schematic sectional view of the tenth example process of manufacturing the printing plate according to the embodiment of the present invention;

FIG. 53 is a schematic sectional view of the tenth example process of manufacturing the printing plate according to the embodiment of the present invention;

FIG. 54 is a flowchart of a printing method according to the embodiment of the present invention;

FIG. 55 is a schematic sectional view of a step of the printing method according to the embodiment of the present invention;

FIG. 56 is a schematic sectional view of a step of the printing method according to the embodiment of the present invention;

FIG. 57 is a schematic sectional view of a step of the printing method according to the embodiment of the present invention;

FIG. 58 is a schematic sectional view of a step of the printing method according to the embodiment of the present invention;

FIG. 59 is a schematic sectional view of a step of another example printing method according to the embodiment of the present invention;

FIG. 60 is a schematic sectional view of a step of the other example printing method according to the embodiment of the present invention;

FIG. 61 is a schematic sectional view of a step of the other example printing method according to the embodiment of the present invention;

FIG. 62 is a schematic view of a printing result for Example 1;

FIG. 63 is a schematic view of the cross-sectional profile of the printing result for Example 1;

FIG. 64 is a schematic view of a first inking result in Example 1;

FIG. 65 is a schematic view of a second inking result in Example 1;

FIG. 66 is a schematic view of a printing result after first inking in Example 1;

FIG. 67 is a schematic view of a printing result after second inking in Example 1;

FIG. 68 is a schematic view of a third inking result in Example 1;

FIG. 69 is a schematic view of an inking result in Comparative Example 1;

FIG. 70 is a graph of time-of-flight secondary ion mass spectrometry measurements for Samples 1 to 5; and

FIG. 71 is a graph of time-of-flight secondary ion mass spectrometry measurements for Samples 1 to 5.

### DESCRIPTION OF THE PREFERRED EMBODIMENTS

Printing plates and printing methods according to preferred embodiments of the present invention will now be described in detail with reference to the attached drawings.

In the following description, any numerical range expressed as “ . . . to . . . ” includes the values on both sides. For example, if a is expressed as “value α1 to value β1”, the range of a includes the values α1 and β1, and its mathematical expression is α1≤ε≤β1.

“Parallel”, “perpendicular”, and “orthogonal” representing angles and other particular angles may contain errors within a range commonly acceptable in the art. In addition, “entire surface” and other concepts representing ranges may contain errors within a range commonly acceptable in the art.

A printing apparatus for use in printing with a printing plate will be described first.

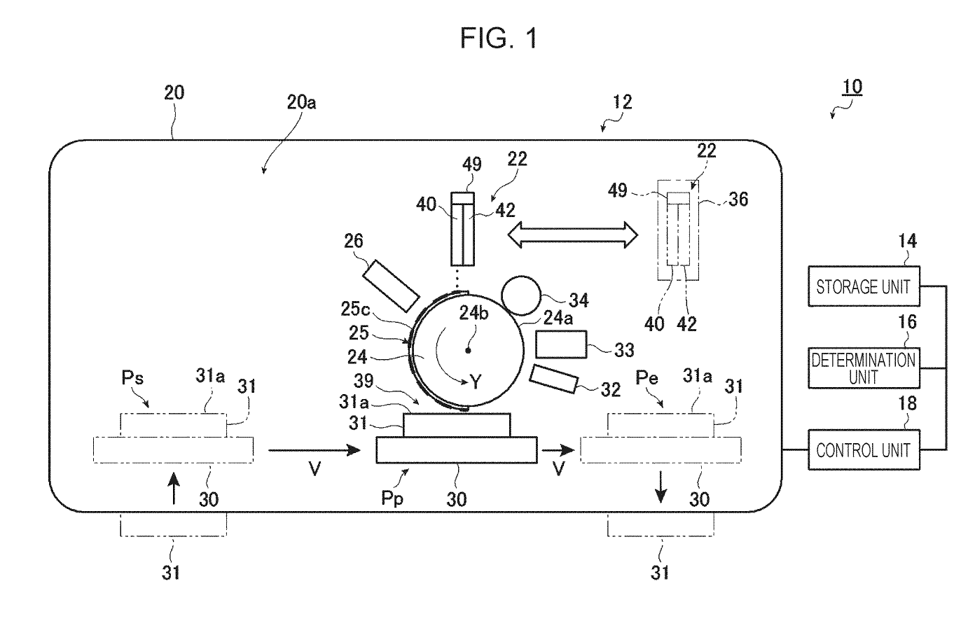

FIG. 1 is a schematic view of an example printing apparatus for use in printing with a printing plate according to an embodiment of the present invention.

As shown in FIG. 1, a printing apparatus 10 has a printing apparatus body 12, a storage unit 14, a determination unit 16, and a control unit 18.

The printing apparatus body 12 forms a predetermined pattern on a substrate 31 by printing with a printing plate 25. The printing apparatus body 12 will be described in detail later.

The storage unit 14 stores various types of information used by the printing apparatus 10. The storage unit 14 stores reference shape information, which serves as a reference for a plate surface 25c of the printing plate 25 after the application of a printing ink to a particular pattern.

For example, the reference shape information is image data representing the ideal condition after the application of a printing ink to a pattern-forming region formed by an image area 25a of the printing plate 25. If the printing ink is applied to the pattern-forming region of the printing plate 25 multiple times, the reference shape information is image data representing the ideal condition for each application. For example, if the printing ink is applied to the pattern-forming region by ejecting the printing ink onto the pattern-forming region by an inkjet process to form dots, the reference shape information is image data representing the ideal arrangement of dots formed by the ejection of the printing ink for each application.

The reference shape information also includes image data representing the ideal condition of the plate surface 25c of the printing plate 25 after transfer.

The storage unit 14 also stores pattern data about the pattern to be printed. This pattern data is input from an external source as appropriate. The reference shape information and the pattern data may be input in any manner to the storage unit 14. The storage unit 14 can be provided with various interfaces, and the reference shape information and the pattern data can be input via storage media and wired and wireless networks.

As described in detail later, the storage unit 14 also stores ejection pattern data and ejection timing data for the printing ink ejected from an inkjet head 40 as well as corrected pattern data, which is ejection pattern data for the printing ink corrected depending on the attachment condition of the printing plate 25.

The ejection pattern data for the printing ink is data representing the ejection pattern for the application of the printing ink to the pattern region of the printing plate 25 using the inkjet head 40.

The ejection timing data is data representing what timing to eject the printing ink to the pattern region of the printing plate 25 when the printing ink is applied to the pattern region of the printing plate 25 using the inkjet head 40.

The determination unit 16 is used to acquire information about the attachment of the printing plate 25 to a plate cylinder 24. The determination unit 16 identifies the positions of alignment marks A to D from alignment mark position information obtained by an alignment camera 42, described later. The determination unit 16 can thus acquire information about the attachment of the printing plate 25 to the plate cylinder 24.

Based on the information about the attachment position of the printing plate 25, the determination unit 16 compares the tilt angle of the printing plate 25 with its acceptable range and determines whether the tilt angle of the printing plate 25 falls within its acceptable range. The determination unit 16 outputs determination information depending on the determination result to the control unit 18. The tilt angle of the printing plate 25 will be described later.

The determination unit 16 compares information about the plate surface 25c of the printing plate 25 after the application of the printing ink to the particular pattern, which is obtained by a plate-surface observation unit 26 of the printing apparatus body 12, as described later, with the reference shape information stored in the storage unit 14, which serves as a reference for the plate surface 25c of the printing plate 25 after the application of the printing ink to the particular pattern, and determines whether the printing ink lies within a predetermined range with respect to the reference shape. The determination unit 16 outputs determination information depending on the determination result to the control unit 18.

If the printing ink lies beyond the predetermined range, the determination unit 16 also identifies, for example, the position where the printing ink lies beyond the predetermined range. For example, if the printing ink is applied beyond the pattern region, the determination unit 16 identifies the position where the printing ink lies beyond the pattern region. In addition, if the printing ink is applied to the pattern region by an inkjet process, the determination unit 16 can identify, for example, misaligned dots formed by the printing ink and missing dots. Depending on the identified position, the control unit 18 adjusts the amount of printing ink ejected and other settings, as described later.

Based on the information about the attachment of the printing plate 25 obtained by the alignment camera 42, if the printing plate 25 is placed at a tilt angle β with respect to the ideal placement of the printing plate, the determination unit 16 multiplies the ejection pattern data for the printing ink by cos β depending on the tilt angle β to generate corrected pattern data. This corrected pattern data is stored in the storage unit 14.

For example, the determination unit 16 generates corrected pattern data when the determination unit 16 compares the tilt angle β of the printing plate 25 with its acceptable range based on the information about the attachment of the printing plate 25 and determines that the tilt angle β falls beyond its acceptable range.

The determination unit 16 also calculates the amount of rotation of the inkjet head 40 based on the information about the attachment position of the printing plate 25 obtained by the plate-surface observation unit 26 and stores the calculated amount of rotation in the storage unit 14. Based on the amount of rotation, the control unit 18 rotates the inkjet head 40 and causes the inkjet head 40 to eject the printing ink.

The control unit 18 is connected to the printing apparatus body 12, the storage unit 14, and the determination unit 16 and controls each of the printing apparatus body 12, the storage unit 14, and the determination unit 16. Furthermore, the control unit 18 controls each unit depending on determination results received from the determination unit 16.

For example, if the determination unit 16 generates corrected pattern data from the ejection pattern data, the control unit 18 causes the inkjet head 40 to eject the printing ink based on the corrected pattern data.

The printing apparatus body 12 will be described next.

The printing apparatus body 12 has various units disposed in the interior 20a of a casing 20 to perform printing in a clean atmosphere. A filter (not shown) and air-conditioning equipment (not shown) are provided to achieve a predetermined cleanliness level in the interior 20a of the casing 20.

The printing apparatus body 12 has an image-recording unit 22, a plate cylinder 24, a plate-surface observation unit 26, a stage 30, a drying unit 32, an ionizer 33, a cleaning unit 34, and a maintenance unit 36.

The image-recording unit 22, the plate-surface observation unit 26, the drying unit 32, the ionizer 33, and the cleaning unit 34 are arranged around the surface 24a of the plate cylinder 24. The cleaning unit 34 is disposed in contact with the surface 24a of the plate cylinder 24.

A substrate 31 is mounted on the stage 30 such that the printing plate 25 is brought into contact with the surface 31a of the substrate 31 by the rotation of the plate cylinder 24 when the stage 30 is located at a printing position Pp below the plate cylinder 24. Thus, a predetermined pattern of printing ink is transferred from the plate surface 25c of the printing plate 25 to the surface 31a of the substrate 31. The plate cylinder 24 and the stage 30 form a transfer unit 39.

The printing ink printed on the substrate 31 is baked with, for example, heat or light, depending on the properties of the printing ink. Known techniques used for baking printing ink with heat or light can be employed as appropriate. The printing ink on the substrate 31 may be baked in the interior 20a of the casing 20 or outside the casing 20.

The printing apparatus 10 applies a printing ink to the pattern-forming region of the printing plate 25 mounted on the plate cylinder 24. The printing ink may be applied either once or multiple times. If the printing ink is applied multiple times, the plate cylinder 24 is rotated the number of times the printing ink is applied. For example, if the printing ink is applied four times, the plate cylinder 24 is rotated four times. The application of the printing ink is referred to as “inking”. When the printing ink is applied multiple times, each application is also referred to as “scan”.

The various units of the printing apparatus body 12 will now be described.

The image-recording unit 22 applies a printing ink to a predetermined pattern-forming region of the plate surface 25c of the printing plate 25. The image-recording unit 22 applies a predetermined pattern of printing ink to the plate surface 25c. The image-recording unit 22 may employ any image recording process, for example, an inkjet process.

The plate cylinder 24 is rotatable about a rotating shaft 24b in one direction, for example, in the Y direction. The Y direction is the rotational direction. The Y direction is also referred to as “feed direction”. While supporting the printing plate 25, the plate cylinder 24 is rotated to transfer a predetermined pattern of printing ink from the plate surface 25c of the printing plate 25 to the surface 31a of the substrate 31.

The rotating shaft 24b is provided with, for example, a motor (not shown) for rotating the plate cylinder 24 with a gear (not shown) or other member therebetween. Alternatively, the rotating shaft 24b may be provided with a direct drive motor without a gear therebetween. The motor is controlled by the control unit 18. The rotating shaft 24b is also provided with a rotary encoder (not shown) for detecting rotation and the amount of rotation. The rotary encoder is connected to the control unit 18, which detects the amount of rotation of the plate cylinder 24.

The target substrate 31 may be any substrate, including film substrates such as polyethylene naphthalate (PEN), polyethylene terephthalate (PET), and polycarbonate (PC) films, glass epoxy substrates, ceramic substrates, and glass substrates. Other substrate materials used for electronic devices can also be used as appropriate. If the printing plate 25 is a rigid substrate such as a glass substrate, transfer may be performed by securing the substrate 31 to the stage 30 and bringing the substrate 31 into close contact with the plate cylinder 24, as described above.

If the printing plate 25 is a film, transfer may be performed using an impression cylinder by securing the film to the impression cylinder and bringing the film into close contact with the plate cylinder 24.

The plate-surface observation unit 26 is disposed downstream of the image-recording unit 22 in the Y direction of the plate cylinder 24. The plate-surface observation unit 26 acquires information about the plate surface 25c of the printing plate 25 after the application of the printing ink. The plate-surface observation unit 26 also acquires information about the plate surface 25c of the printing plate 25 after the transfer of the printing ink to the substrate 31.

The plate-surface observation unit 26 may have any configuration that allows it to acquire information about the plate surface 25c of the printing plate 25 before and after the transfer of the printing ink. Since the printing plate 25 is often rectangular, it is preferred to use a line sensor and linear illumination. The information about the plate surface 25c obtained in this case is plate surface image data. As described above, the determination unit 16 compares the plate surface image data with the reference shape information and makes a determination.

The line sensor may be, for example, a monochrome complementary metal-oxide-semiconductor (CMOS) sensor or charge-coupled device (CCD) sensor. The line sensor need not be a color sensor because the line sensor is intended to observe shades of ejected printing ink droplets. Lenses and other members such as various filters may also be provided in front of the line sensor. The linear illumination may be, for example, a linear light-emitting diode (LED) array.

The plate-surface observation unit 26 is connected to the control unit 18, which controls the timing when the plate-surface observation unit 26 acquires information about the plate surface 25c of the printing plate 25. The acquired information about the plate surface 25c of the printing plate 25 is stored in the storage unit 14.

If the printing ink is a transparent ink such as an insulator, the transparent ink is difficult to recognize by the naked eye. The recognition of the printing ink by the line sensor can be improved, for example, by providing a polarizing filter in front of the light source or the line sensor or by illuminating the printing ink from two or more positions.

In addition, the acquisition of the information about the plate surface 25c of the printing plate 25 may be performed for each scan, which allows the detection of landing misalignment, satellites, and uneven film thickness due to variations in the volume of droplets ejected. The film thickness can be estimated, for example, by measuring the relationship between film thickness and optical properties in advance, storing the measured relationship in the storage unit 14, and comparing the detected optical properties with that relationship.

If the printing ink is a silver nanoparticle ink, the silver nanoparticle ink changes in color or reflectance as it dries and turns silvery. A thinner film dries faster, whereas a thicker film dries slower; thus, the film thickness can be estimated by measuring the relationship between film thickness and color or between film thickness and reflectance in advance over a predetermined period of time until detection.

If the printing ink is a transparent ink such as an insulator, the film thickness can be determined from interference fringes. The film thickness can be estimated by measuring the relationship between film thickness and interference fringes in advance. If the printing ink is a crystalline ink such as a semiconductor, a polarizing filter may be provided so that the film thickness can be estimated from color. In this case, the film thickness can be estimated by measuring the relationship between film thickness and color in advance.

The stage 30 is moved in the transport direction V to transport the substrate 31 mounted thereon to a predetermined position. The stage 30 is provided with a transport mechanism (not shown). This transport mechanism is connected to the control unit 18, which controls the transport mechanism to move the stage 30 in the transport direction V and thereby change the position of the stage 30.

The stage 30 first stays at a start position Ps at which a substrate 31 transported from outside the casing 20 is mounted on the stage 30. The stage 30 is then moved to a printing position Pp under the plate cylinder 24. After printing, the stage 30 having the printed substrate 31 mounted thereon is moved to an end position Pe. Thereafter, the substrate 31 is taken out of the casing 20. The stage 30 is moved from the end position Pe to the start position Ps and stays there until another substrate 31 is transported into the casing 20.

The drying unit 32 dries the printing ink on the plate surface 25c of the printing plate 25. The drying method may be any method that allows the printing ink to be dried, for example, hot or cold air blowing from a fan, heating with an infrared heater, radio-frequency irradiation, or microwave irradiation.

The drying unit 32 need not necessarily be provided if the printing ink on the plate surface 25c of the printing plate 25 can be dried naturally. The printing ink may be dried to any degree and may remain in a state before complete dryness, that is, a semi-dry state.

“Semi-thy state” refers to a state in which some of the solvent in the printing ink before application has evaporated therefrom.

A semi-dry state preferred for printing satisfies the following first to third conditions:

1. The printing ink on the plate surface 25c has dried until the printing ink has such a high elasticity that the printing ink does not deform horizontally when exposed to a stress during printing (during the transfer of the printing ink from the printing plate 25 to the substrate 31), that is, the printing ink does not have a poorly shaped pattern after printing.

2. The printing ink has dried until the cohesion of the printing ink increases to such an extent that the printing ink does not exhibit a cohesive failure (a phenomenon in which the printing ink remains on both the plate surface 25c of the printing plate 25 and the substrate 31 after transfer) upon printing.

3. The printing ink has dried to such an extent that the printing ink does not exhibit a transfer failure (failure to transfer the printing ink from the plate surface 25c of the printing plate 25 to the substrate 31) upon printing, that is, has not overdried until the adhesion of the printing ink to the plate surface 25c of the printing plate 25 exceeds the adhesion of the printing ink to the substrate 31.

The ionizer 33 eliminates static electricity from the plate surface 25c of the printing plate 25. By eliminating static electricity from the plate surface 25c of the printing plate 25, the ionizer 33 reduces the deposition of foreign materials such as debris and dust on the plate surface 25c of the printing plate 25. The ionizer 33 can also prevent the deflection of the printing ink, which may be deflected by any charge on the plate surface 25c of the printing plate 25, thus improving the inkjet ejection accuracy.

The ionizer 33 can be a static eliminator, for example, a corona-discharge static eliminator or an ionizing static eliminator. Although the ionizer 33 is provided downstream of the drying unit 32 in the Y direction, the ionizer 33 may be provided at any position where the ionizer 33 can eliminate static electricity from the plate surface 25c of the printing plate 25 before recording at the image-recording unit 22.

The cleaning unit 34 removes the printing ink from the plate cylinder 24 and the printing plate 25. The cleaning unit 34 may have any configuration that allows it to remove the printing ink from the plate cylinder 24 and the printing plate 25. For example, the cleaning unit 34 may be configured such that the printing ink is transferred to a roller pressed against the plate cylinder 24 and is then wiped off the roller.

The maintenance unit 36 checks whether the image-recording unit 22 exhibits a predetermined performance in terms of ejection and other properties. The maintenance unit 36 performs maintenance such as the wiping of nozzles so that the image-recording unit 22 exhibits a predetermined performance. The maintenance unit 36 is provided at a position away from the plate cylinder 24. The image-recording unit 22 is moved to the maintenance unit 36, for example, via a guide rail (not shown). The maintenance unit 36 will be described in detail later.

The image-recording unit 22 will now be described in detail.

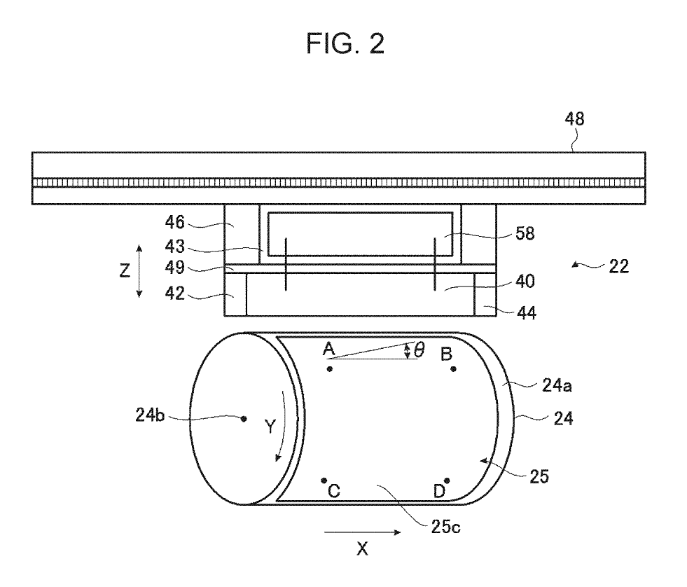

FIG. 2 is a schematic view of an image-recording unit of the printing apparatus according to the embodiment of the present invention.

An inkjet recording unit will be described as an example of the image-recording unit 22.

As shown in FIG. 2, the image-recording unit 22 has an inkjet head 40, an alignment camera 42, a laser displacement meter 44, and a rotating unit 49 that are mounted on a carriage 46. The carriage 46 is movable by a linear motor 48 in a direction parallel to the rotating shaft 24b of the plate cylinder 24, that is, in the X direction, and the inkjet head 40 is movable by the carriage 46 in the X direction. The position of the carriage 46 can be calculated from a reading on a linear scale (not shown) provided for the linear motor 48.

The inkjet head 40 is an ink-applying unit. The inkjet head 40 is provided with an ejection control unit 43 for controlling ink ejection. The ejection control unit 43 adjusts the ejection waveform for the printing ink. The ejection control unit 43 is connected to the control unit 18. For example, the ejection control unit 43 allows a user to adjust the ejection voltage or the ejection waveform via a user interface. As discussed later, the printing ink is ejected at a controlled temperature.

The alignment camera 42 and the laser displacement meter 44 are also connected to the control unit 18. The carriage 46 is provided with a driving unit (not shown) for moving the carriage 46 in the Z direction. The driving unit is connected to the control unit 18, which controls the movement of the carriage 46 in the Z direction. Here, “Z direction” refers to a direction perpendicular to the surface 24a of the plate cylinder 24.

The alignment camera 42 is intended to acquire alignment mark position information for correcting the position where the printing ink is ejected, the timing when the printing ink is ejected, and the pattern data.

The alignment camera 42 may have any configuration that allows it to detect the alignment marks A to D.

After the alignment camera 42 captures an image of the alignment marks A to D, the image data is stored in the storage unit 14, and the determination unit 16 identifies the positions of the alignment marks A to D. The alignment camera 42 and the determination unit 16 function as an attachment-position-information acquisition unit that acquires information about the attachment of the printing plate 25 to the plate cylinder 24.

The information about the positions of the alignment marks A and B can be used to obtain information about the position where the ejection of the printing ink is started in the Y direction, the extension and contraction of the printing plate in the X direction, and the tilt angle θ of the printing plate. The information about the positions of the alignment marks A and C can be used to obtain information about the position where the ejection of the printing ink is started in the X direction and the extension and contraction of the printing plate in the Y direction. The information about the positions of the alignment marks A to D can be used to obtain, for example, information about trapezoidal distortion of the printing plate, that is, trapezoidal distortion information. The position where the ejection of the printing ink is started is referred to as “inking start position”.

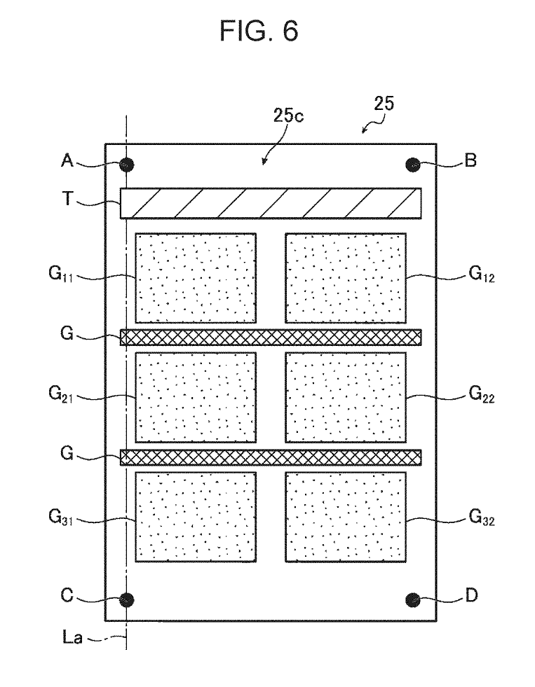

Ideally, a line La (see FIG. 6) passing through the alignment marks A and C of the printing plate 25 is parallel to the Y direction. The printing plate 25, however, is slightly tilted with respect to the plate cylinder 24 when attached to the plate cylinder 24. The information about the positions of the alignment marks A to D can be used to obtain information about the attachment of the printing plate 25 to the plate cylinder 24, for example, information about the tilt of the printing plate 25 with respect to the Y direction of the plate cylinder 24.

The various types of information thus obtained are used to correct the position where the ejection of the printing ink is started, the position of the inkjet head 40, and the timing when the printing ink is ejected. These corrections can be made by known correction techniques for the deposition of droplets of printing ink by an inkjet process.

Enlargement and reduction in the X direction, enlargement and reduction in the Y direction, and tilt and trapezoidal distortion corrections can be made to the pattern data by known correction methods.

At least three alignment marks can be used to obtain information about the extension and contraction of the printing plate in the X direction, the tilt angle θ of the printing plate, and the extension and contraction of the printing plate in the Y direction. Four alignment marks are preferred because they can be used to obtain information about trapezoidal distortion of the printing plate 25. If a plurality of alignment marks are further provided inside the alignment marks A to D, nonlinear corrections can be made. In this case, corrections using alignment marks can be performed by known correction methods.

The laser displacement meter 44 measures the distance between the inkjet head 40 and the plate surface 25c of the printing plate 25. The distance between the alignment marks A and C in the Y direction, that is, the AC length, changes as the sum of the plate cylinder diameter and the plate thickness changes with, for example, temperature and the swelling of the plate with the printing ink. Since the inkjet head 40 ejects the printing ink at the timing determined by the rotary encoder, the AC length corresponds to a change in plate length without being affected by a change in plate cylinder diameter; however, the length changes when the printing ink is transferred to the substrate 31.

To print a pattern on the substrate 31 at constant length irrespective of the change in AC length, the laser displacement meter 44 is used to measure the change in the sum of the plate cylinder diameter and the plate thickness. Corrections are made based on the measurement results.

A specific example of a correction is to precisely measure the change in the distance between the rotating shaft 24b of the plate cylinder 24 and the plate surface 25c of the printing plate 25 and, based on the results, change the relative moving speed of the plate cylinder 24 and the substrate 31 during transfer.

Another specific example of a correction is to measure the temperature of the plate cylinder 24 or the ambient temperature and change the relative moving speed of the plate cylinder 24 and the substrate 31 during transfer based on a table, created in advance, of the relationship between temperature and the distance between the rotating shaft 24b of the plate cylinder 24 and the plate surface 25c of the printing plate 25.

These specific examples of corrections allow accurate printing irrespective of plate swelling or changes in plate cylinder diameter. It is known that a difference in feed speed between the plate side and the substrate side during transfer results in a change in the size of the transferred pattern in the feed direction.

The laser displacement meter 44 may have any configuration that allows it to measure the distance between the inkjet head 40 and the plate surface 25c of the printing plate 25.

By measuring the distance to the plate surface 25c of the printing plate 25, the laser displacement meter 44 can measure the change in the sum of the plate cylinder diameter and the plate thickness. This can be used for enlargement and reduction in the Y direction. For example, the length between the alignment marks A and C changes as the diameter of the plate cylinder 24 or the thickness of the printing plate 25 changes with temperature changes. This change in length can be used for the correction of the pattern data.

As described above, the use of the alignment camera 42 and the laser displacement meter 44 increases the alignment accuracy. As described later, the printing apparatus 10 is used for the formation of thin-film transistors. For thin-film transistors, even a misalignment of about 10 μm results in their characteristics differing from the design characteristics. When a plurality of thin-film transistors are formed, even a misalignment of about 10 μm results in variations in characteristics, and such thin-film transistors do not exhibit high performance, for example, when used for electronic paper. Such variations in characteristics can be reduced.

The rotating unit 49 rotates the inkjet head 40 about a line perpendicular to the surface 24a of the plate cylinder 24. The rotating unit 49 can be used to adjust the orientation of the inkjet head 40 to the tilt of the printing plate 25.

The printing ink may be ejected from the inkjet head 40 by any process, including various processes such as piezoelectric processes, in which a liquid is ejected by bending deformation, shear deformation, longitudinal vibration, or other mode of operation of piezoelectric elements; thermal processes, in which a liquid in a liquid chamber is heated with a heater to eject the liquid by film boiling; and electrostatic processes, in which electrostatic force is used.

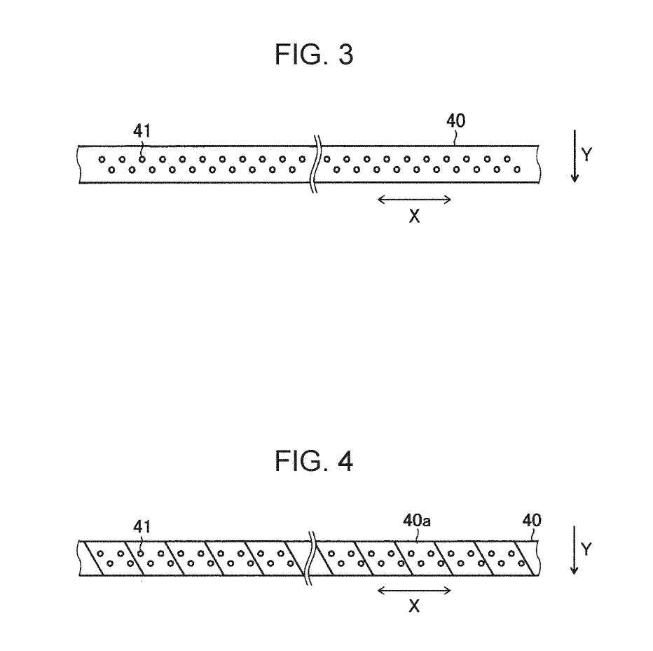

A specific configuration of the inkjet head 40 is shown in FIG. 3, where a plurality of nozzles 41 are arranged in the X direction so as to be staggered in the Y direction over the length corresponding to the entire width of the printing plate 25.

By arranging the nozzles 41 in the X direction so as to be staggered in the Y direction, the nozzles 41 can be densely arranged. The nozzles 41 may be arranged in any number of rows and may be arranged in one, two, or more rows. Alternatively, the nozzles 41 may be arranged in a matrix.

The inkjet head 40 may have any other configuration, for example, the configuration shown in FIG. 4. The inkjet head 40 shown in FIG. 4 has a plurality of head modules 40a connected together in the X direction. In this case, the plurality of head modules 40a need not be connected in a row, but may be connected such that the nozzles 41 of the plurality of head modules 40a are arranged in the X direction so as to be staggered in the Y direction.

For the inkjet head 40 shown in FIG. 4, the ejection waveform can be adjusted by the ejection control unit 43 for each head module 40a. If the ejection control unit 43 is provided for each head module 40a, the ejection waveform can be adjusted for each ejection control unit 43.

The image-recording unit 22 need not use the inkjet head 40 to apply the printing ink; instead, known techniques such as blade coating, bar coating, spray coating, dip coating, spin coating, slit coating, and capillary coating can be employed as appropriate. Of these, the use of a contactless inking method such as inkjet coating or capillary coating for the inking of the printing plate 25 improves the durability of the printing plate 25. For inkjet coating, the printing ink preferably has a viscosity of from 1 mPa·s to 20 mPa·s. For capillary coating, the printing ink preferably has a viscosity of from 1 mPa·s to 30 mPa·s. Inkjet coating is preferred if the thickness of the ink film needs to be controlled.

The ink supply mechanism of the printing apparatus 10 will be described next.

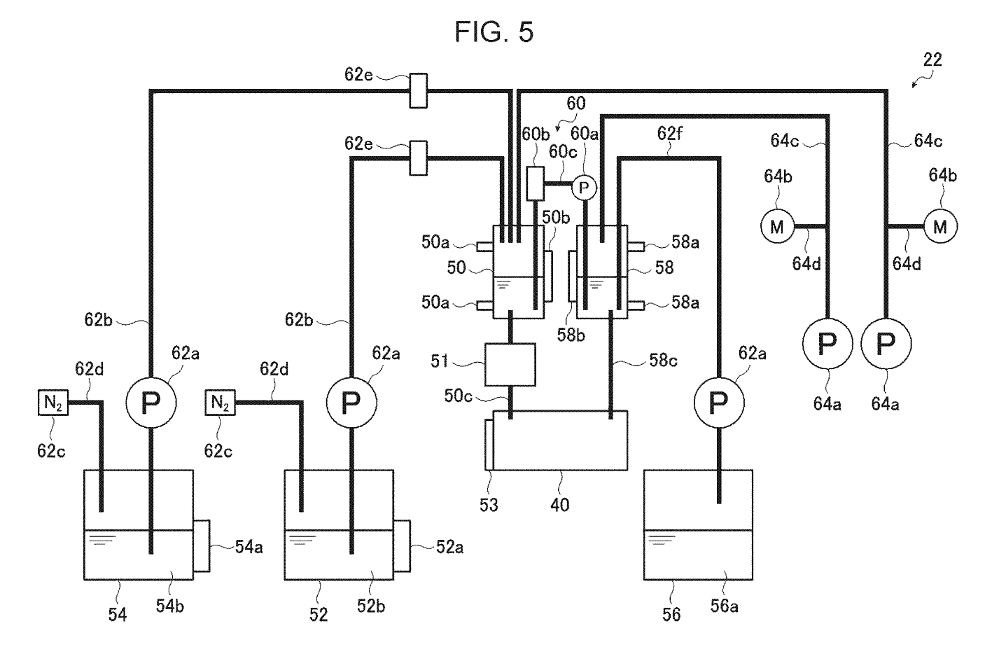

FIG. 5 is a schematic view of an ink supply mechanism of the printing apparatus according to the embodiment of the present invention.

As shown in FIG. 5, the image-recording unit 22 has two subtanks 50 and 58 connected to the inkjet head 40 via pipes 50c and 58c, respectively. The pipe 50c is provided with a degassing unit 51. The degassing unit 51 degasses the printing ink to be supplied to the inkjet head 40, and known degassing units can be used as appropriate.

The subtank 50 contains the printing ink to be supplied to the inkjet head 40. The subtank 50 is provided with two liquid level sensors 50a and a temperature control unit 50b.

The liquid level sensors 50a may have any configuration that allows them to measure the level of the printing ink, and known liquid level sensors can be used as appropriate.

The temperature control unit 50b controls the temperature of the printing ink. This allows the temperature of the printing ink to be controlled. The temperature of the printing ink is preferably, for example, about 15° C. to 30° C. The temperature control unit 50b may have any configuration that allows it to control the temperature of the printing ink, and known temperature control units can be used as appropriate.

The subtank 58 contains printing ink collected from the inkjet head 40. The subtank 58 is provided with two liquid level sensors 58a and a temperature control unit 58b.

The liquid level sensors 58a have a configuration similar to that of the liquid level sensors 50a; therefore, a detailed description thereof is omitted. The temperature control unit 58b also has a configuration similar to that of the temperature control unit 50b; therefore, a detailed description thereof is omitted.

A circulating unit 60 for moving the printing ink from the subtank 58 to the subtank 50 is provided. The circulating unit 60 has a pipe 60c connecting the subtank 50 to subtank 58 and a pump 60a and a filter 60b provided in the pipe 60c. The pump 60a controls the amounts of ink in the subtanks 50 and 58. The pump 60a may have any configuration that allows it to move the printing ink between the subtanks 50 and 58, and known pumps can be used as appropriate. The filter 60b removes debris and other materials from the printing ink as the printing ink moves from the subtank 58 to the subtank 50 through the filter 60b.

The subtanks 50 and 58 each have a pipe 64c inserted therein. The pipes 64c are provided with pumps Ma. The pipes 64c also have pressure sensors 64b connected thereto via pipes 64d. Although not shown, the pipes 64c and 64d are provided with valves or other members. This allows nitrogen gas to be charged into the subtanks 50 and 58. The amount of nitrogen gas charged can be changed to generate a pressure difference between the subtanks 50 and 58, thereby facilitating circulation.

The pressures in the subtanks 50 and 58 can be measured by the pressure sensors 64b. The measurements of the pressures in the subtanks 50 and 58 from the pressure sensors 64b can be used to control the meniscus negative pressure of the inkjet head 40 and the amount of ink circulated.

The subtank 50 has an ink tank 52 connected thereto via a pipe 62b. The pipe 62b is provided with a pump 62a and a filter 62e. The ink tank 52 is filled with a printing ink 52b.

The ink tank 52 is provided with a temperature control unit 52a. The temperature control unit 52a has a configuration similar to that of the temperature control unit 50b; therefore, a detailed description thereof is omitted.

The ink tank 52 also has, for example, a nitrogen gas cylinder 62c connected thereto via a pipe 62d. This allows nitrogen gas to be charged into the ink tank 52.

The subtank 50 also has a cleaning liquid bottle 54 connected thereto via a pipe 62b. The pipe 62b is provided with a pump 62a and a filter 62e. The cleaning liquid bottle 54 is filled with a cleaning liquid 54b.

The cleaning liquid bottle 54 is provided with a temperature control unit 54a. The temperature control unit 54a has a configuration similar to that of the temperature control unit 50b; therefore, a detailed description thereof is omitted.

The cleaning liquid bottle 54 also has, for example, a nitrogen gas cylinder 62c connected thereto via a pipe 62d. This allows nitrogen gas to be charged into the cleaning liquid bottle 54.

The temperature of the printing ink can be controlled by the temperature control unit 52a. Preferably, the temperature of the printing ink in the subtank 50 is higher than the temperature of the printing ink in the ink tank 52.

The subtank 58 has a waste liquid tank 56 connected thereto via a pipe 62f. The pipe 62f has a pump 62a connected thereto. This allows the printing ink 52b to be moved from the subtank 58 into the waste liquid tank 56 as waste liquid.

The printing ink 52b may be a metal nanoparticle ink for inkjet applications. Specifically, inkjet-type Ag nanoparticle inks (Ag1teH (model No.) and L-Ag1TeH (model No.)) and Au nanoparticle inks (cyclododecene solvent) available from ULVAC, Inc. can be used. Various other inks can also be used as appropriate.

The maintenance unit 36 will be described in detail next.

The maintenance unit 36 has, for example, a rotating roller (not shown) that rotates about its rotational axis relative to the inkjet head 40. A web (not shown) for cleaning the inkjet head 40 is wound around the circumferential surface of the rotating roller. The web may be any web that can clean the inkjet head 40.

For example, a cleaning liquid is directly applied or ejected onto the inkjet head 40 by a cleaning unit, and the rotating roller is rotated to bring the web into contact with the inkjet head 40 and thereby remove the printing ink 52b therefrom. Alternatively, the cleaning liquid may be ejected onto the web by the cleaning unit, and the rotating roller may be rotated to bring the web into contact with the inkjet head 40 and thereby remove the printing ink 52b therefrom.

The cleaning liquid may be, for example, a solvent capable of dissolving the ink or a solution containing all ink components excluding solids. Hydrocarbon solvents can be used for inkjet-type Ag nanoparticle inks (Ag1teH (model No.) and L-Ag1TeH (model No.)) and Au nanoparticle inks (cyclododecene solvent) available from ULVAC, Inc. Examples of hydrocarbon solvents that can be used include toluene, xylene, hexane, tetradecane, and cyclododecene.

Examples of webs that can be used include wiping cloths such as Savina (registered trademark) available from KB Seiren, Ltd., Toraysee (registered trademark) available from Toray Industries, Inc., and Nanofront (registered trademark) and MicroStar (registered trademark) available from Teijin Limited.

The inkjet head 40 need not be cleaned in the manner described above. For example, a configuration having a rubber blade (not shown) can instead be used. Since the inkjet head 40 is movable by the carriage 46 in the X direction, this motion is used to wipe the printing ink off the inkjet head 40 with a fixed rubber blade in the longitudinal direction. Alternatively, wiping may be performed by scanning the rubber blade while fixing the inkjet head 40. In this case, wiping the printing ink off the inkjet head 40 in a lateral direction orthogonal to the longitudinal direction provides the advantage of shortening the moving distance of the rubber blade and also provides the advantage of reducing the likelihood of the wiped-off printing ink entering other nozzles. On the other hand, wiping the printing ink off the inkjet head 40 in a direction parallel to the longitudinal direction provides the advantage of sharing the X-axis with the inkjet head 40. Thus, the optimum design is preferably employed by taking into account the apparatus configuration and cost.

A cleaning liquid may be applied to the rubber blade or the inkjet head 40 before the printing ink is wiped off. When the printing ink is wiped off, the pressures in the subtanks 50 and 58 can be set to levels different from those for printing. The optimum pressure is preferably set depending on the printing ink, the inkjet head 40, and the wiping conditions.

If a web (not shown) is used, the web is moved for wiping while the inkjet head 40 is moved, for example, in the X direction. This allows the web surface to be constantly refreshed. The web may be the same as above.

It is possible to perform at least one of wiping off the printing ink with a web impregnated with a cleaning liquid in advance or wiping off the printing ink after applying a cleaning liquid to the inkjet head 40. When the printing ink is wiped off, the pressures in the subtanks 50 and 58 can be set to levels different from those for printing. The optimum pressure is preferably set depending on the printing ink, the inkjet head 40, and the wiping conditions.

The maintenance unit 36 can also cause the inkjet head 40 to perform operations such as purging, spitting, and dripping.

Here, “purging” refers to positioning the inkjet head 40 over an ink receiver (not shown) and, in this state, creating a positive pressure in the subtank 50 to force the printing ink out of the nozzles 41. The ink receiver may be shared with the cap and the wiping unit.

“Spitting” refers to an ejection operation. This improves nozzle clogging and deflection upon ejection. Although spitting is performed at a site similar to that for purging, a spitting station may be provided. In this case, it is preferred to perform suction under the inkjet head 40 so that the ejected printing ink does not become airborne. For spitting, a high driving voltage is applied to the inkjet head 40 as compared to the ejection waveform for printing, or a dedicated waveform is used. The dedicated waveform is set to achieve a large volume of ink droplet and a high printing ink ejection speed as compared to the ejection waveform for printing.

“Dripping” refers to a recovery operation in which the printing ink is allowed to drip slowly, rather than a recovery operation in which the printing ink is forced out as in the purging operation. This improves nozzle clogging and deflection of the printing ink upon ejection. Dripping is performed at a site similar to that for purging or spitting. For dripping, a positive pressure is created with respect to the pressure for printing in the subtank 50. However, it is preferred that the pressure in the subtank 50 be positive with respect to the atmospheric pressure but be lower than the purging pressure.

To prevent the nozzles 41 from drying, the maintenance unit 36 may have a capping mechanism (not shown). The capping mechanism caps the nozzles 41 and then fills the area around the nozzles 41 with nitrogen gas. The nozzles 41 can be more effectively prevented from drying by placing a web or other member impregnated with a cleaning liquid in the cap.

The maintenance unit 36 may also have the function of observing the printing ink 52b ejected from the inkjet head 40. The maintenance unit 36 may have an ejection observation unit (not shown) for observing ink droplets 45 ejected from the inkjet head 40 and a nozzle observation unit (not shown) for observing the nozzles 41 (see FIG. 3) of the inkjet head 40 from the side where the nozzles 41 are formed.

The ejection observation unit and the nozzle observation unit are connected to the control unit 18, which controls the operation thereof. The control unit 18 stores the resulting image data in the storage unit 14. The control unit 18 compares the printing ink ejection condition of the inkjet head 40 with, for example, a design value related to the ejection properties of the inkjet head 40. The comparison results are stored in the storage unit 14.

The printing plate 25 will be described next.

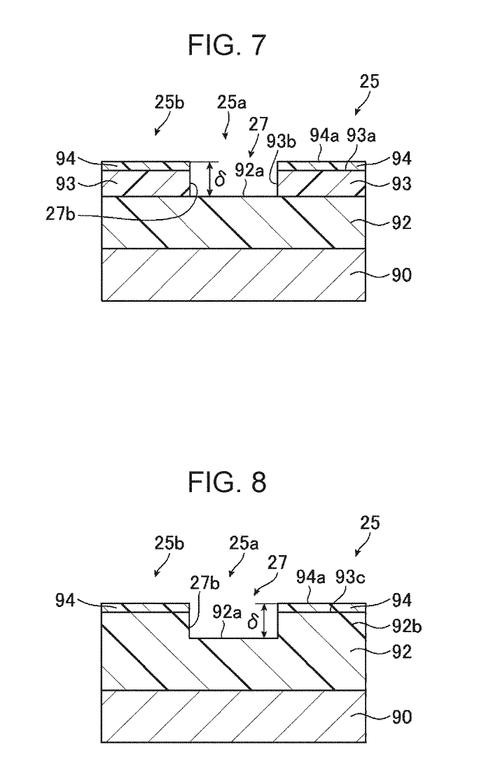

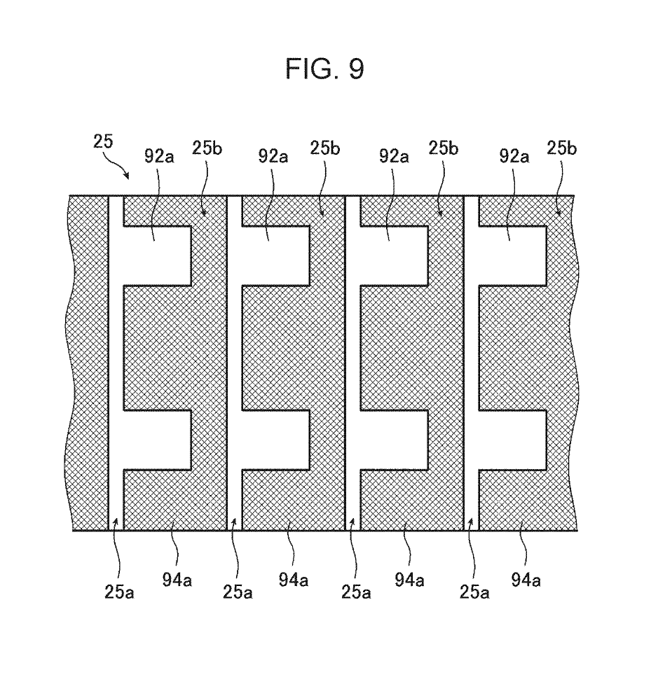

FIG. 6 is a schematic plan view of the printing plate according to the embodiment of the present invention. FIG. 7 is a schematic sectional view of an example printing plate according to the embodiment of the present invention. FIG. 8 is a schematic sectional view of another example printing plate according to the embodiment of the present invention. FIG. 9 is a schematic plan view of an example printing pattern of the printing plate according to the embodiment of the present invention.

As shown in FIG. 6, for example, the printing plate 25 has the alignment marks A to D at the four corners thereof and has formed thereon an ejection check area T, printing areas G₁₁ and G₁₂, a spitting area G, printing areas G₂₁ and G₂₂, a spitting area G, and printing areas G₃₁ and G₃₂.

The ejection check area T is a region where the printing ink is ejected in a test pattern from the inkjet head 40. After checking, the printing ink is removed from the ejection check area T by the cleaning unit 34 or is removed by transfer to the substrate 31.

The spitting areas G are regions where the printing ink is ejected from the inkjet head 40 by normal ejection operation and are used for checking ejection.

Since the regions for checking ejection, namely, the ejection check area T and the spitting areas G, are provided before the printing areas G₁₁, G₁₂, G₂₁, G₂₂, G₃₁, and G₃₂, the printing ink can be reliably ejected onto the printing areas G₁₁, G₁₂, G₂₁, G₂₂, G₃₁, and G₃₂.

A pattern-forming region and a non-pattern-forming region, described later, are provided in the printing areas G₁₁, G₁₂, G₂₁, G₂₂, G₃₁, and G₃₂.

The printing plate 25 shown in FIG. 7 has an image area 25a and a non-image area 25b other than the image area 25a.

The image area 25a of the printing plate 25 is a recessed area 27 serving as a pattern-forming region. The image area 25a, that is, the recessed area 27, is formed by a layer containing silicone rubber, as described later. The non-image area 25b is a raised area serving as a non-pattern-forming region. The non-image area 25b, that is, the raised area, is formed by a layer containing a fluorine compound, as described later.

The pattern-forming region is a region for forming, for example, gate electrodes and wiring lines. The printing ink is transferred from the image area 25a of the printing plate 25 to the substrate 31, whereas no printing ink is transferred from the non-image area 25b to the substrate 31.

The printing plate 25 has a silicone rubber layer 92 on a support 90. A silicone rubber layer 93 forming the sidewall of the recessed area 27 is disposed over the surface of the silicone rubber layer 92 excluding the image area 25a. The recessed area 27 is formed by the silicone rubber layers 92 and 93, which serve as a layer containing silicone rubber. The bottom surface of the recessed area 27 is the surface 92a of the silicone rubber layer 92. The side surface 27b of the recessed area 27 is formed by the silicone rubber layer 93, which serves as a layer containing silicone rubber. The depth of the recessed area 27 can be changed by changing the thickness of the silicone rubber layer 93. That is, the plate depth of the printing plate 25 can be changed.

In general, “plate depth” refers to the relative height difference between the image area 25a and the non-image area 25b of the printing plate 25.

The silicone rubber layer 93 forms the raised area of the printing plate 25. A fluorine compound layer 94 serving as a layer containing a fluorine compound is disposed on the surface 93a of the silicone rubber layer 93. The surface 94a of the fluorine compound layer 94 forms the surface of the non-image area 25b. The fluorine compound layer 94 repels the printing ink and exhibits liquid repellency to the printing ink.

The printing plate 25 is a printing plate generally known as an intaglio plate. The height difference δ between the surface of the image area 25a and the surface of the non-image area 25b of the printing plate 25 is from more than 0.1 μm to 10 μm. The height difference δ of the printing plate 25 refers to the distance between the surface 92a of the silicone rubber layer 92 and the surface 94a of the fluorine compound layer 94.

The height difference δ can be determined from a cross-sectional image of the printing plate 25 acquired under a scanning electron microscope.

The fluorine compound layer 94 may have a thickness of from 1 nm to 100 nm, preferably, for example, about 10 nm. If the fluorine compound layer 94 has a thickness of 1 nm or more, the absorption of the solvent can be prevented.

By allowing the silicone rubber layers 92 and 93 to absorb the solvent from the printing ink, the printing ink can be prevented from being repelled by the silicone rubber layers 92 and 93 so that the printing ink can be applied to the silicone rubber layers 92 and 93. In addition, by reducing the absorption of the solvent from the printing ink into the fluorine compound layer 94, the printing ink can be prevented from being pinned on the fluorine compound layer 94 so that no printing ink remains on the fluorine compound layer 94.

The image area 25a of the printing plate 25 is liquid-receptive to the printing ink, that is, an ink-receptive area. The non-image area 25b is liquid-repellent to the printing ink, that is, an ink-repellent area.

Although the printing plate 25 shown in FIG. 7 has the silicone rubber layers 92 and 93, the printing plate 25 need not have this configuration. For example, as shown in FIG. 8, the recessed area 27 may be provided in the silicone rubber layer 92. In this case, the recessed area 27, including the side surface 27b thereof, is formed only by the silicone rubber layer 92. The fluorine compound layer 94 is provided on the outermost surface 92c of the raised area 92b of the silicone rubber layer 92.

For both of the configurations shown in FIGS. 7 and 8, the image area 25a and the non-image area 25b are formed in a particular pattern on the printing plate 25, for example, as shown in FIG. 9. For example, the pattern of the image area 25a is a pattern of gate electrodes and wiring lines and is used to form gate electrodes and wiring lines.

For example, the printing plate 25 can be used for the formation of various electrodes such as gate, source, and drain electrodes of thin-film transistors for use in devices such as electronic paper. The printing plate 25 can also be used for the formation of wiring patterns of electronic circuits and printed wiring boards.

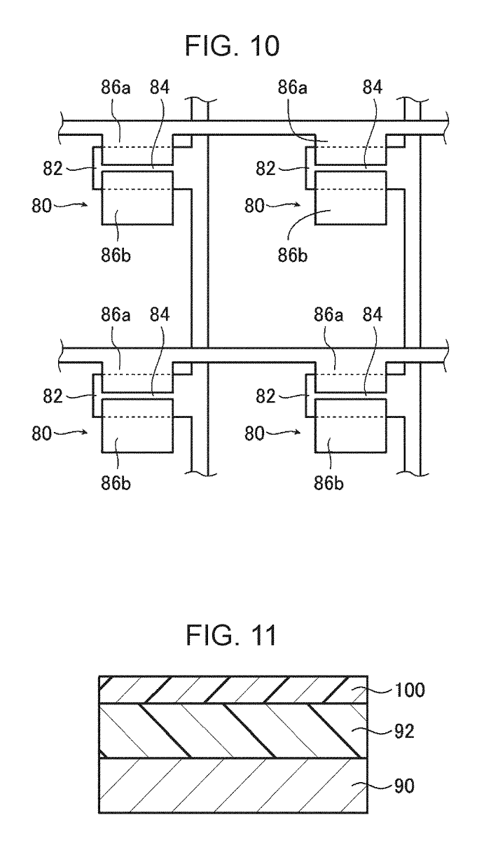

FIG. 10 is a schematic view of example thin-film transistors formed using the printing plate according to the embodiment of the present invention.

Each thin-film transistor 80 (hereinafter referred to as “TFT 80”) shown in FIG. 10 has a gate electrode 82, a gate insulating layer (not shown), a source electrode 86a, a drain electrode 86b, a semiconductor layer (not shown), and a protective layer (not shown).

In each TFT 80, the gate insulating layer (not shown) is formed so as to cover the gate electrode 82. The source electrode 86a and the drain electrode 86b are formed on the gate insulating layer, with a predetermined gap serving as a channel region 84 therebetween. The semiconductor layer (not shown), which functions as an active layer, is formed over the channel region 84. The protective layer (not shown) is formed so as to cover the semiconductor layer, the source electrode 86a, and the drain electrode 86b. The channel region 84 has a channel length on the order of several micrometers to several tens of micrometers. A drain current through a thin-film transistor is affected by its channel length; therefore, variations in channel length lead to variations in the characteristics of thin-film transistors.

In addition to the TFTs 80 shown in FIG. 10, the printing plate 25 can be used for the formation of various patterned films such as electrode films, wiring films, and insulating films. Such various films can be stacked on top of each other to manufacture electronic devices other than the TFTs 80, including electroluminescent transistors, organic electroluminescent elements, and solar cells. The printing plate 25 can also be used for the manufacture of such electronic devices.

The support 90 of the printing plate 25 supports the silicone rubber layer 92 and is formed of, for example, resin, metal, or glass. The support 90 need not be formed only of a single material, but may be formed of a combination of materials. In this case, for example, the support 90 may be a composite of an aluminum sheet and polyethylene terephthalate. The printing plate 25 may also have a configuration without the support 90.

If the printing plate 25 is wound around the plate cylinder 24, the support 90 needs to be flexible. Thus, for example, if the support 90 is formed of polyethylene terephthalate (PET), the desirable thickness is about 50 to 200 μm. If the support 90 is an aluminum sheet, the thickness of the aluminum sheet is preferably 0.1 to 1 mm, desirably 0.15 to 0.4 mm.

The silicone rubber layer 92 of the printing plate 25 forms the image area 25a. Here, “silicone rubber” refers to a rubbery substance containing an organosiloxane main chain and having a network structure. Silicone resins include those that exhibit no rubber elasticity, for example, organosiloxane polymers. Silicone resins also include silicone rubber, as described above.

The silicone rubber layer 92 of the printing plate 25 is formed of, for example, polydimethylsiloxane (PDMS). Polydimethylsiloxane is hereinafter also abbreviated as PDMS. The use of polydimethylsiloxane (PDMS), which has high transfer performance, reduces the amount of printing ink remaining on the printing plate 25 after transfer, thus allowing continuous printing without cleaning the printing plate 25. This improves the printing efficiency.

For example, the silicone rubber layer 92 is formed from an ultraviolet-curable polydimethylsiloxane (PDMS) or a thermosetting polydimethylsiloxane (PDMS). The ultraviolet-curable polydimethylsiloxane (PDMS) can be either of a type that cures in a region irradiated with ultraviolet light or of a type that softens in a region irradiated with ultraviolet light, depending on the method of manufacture.

More specifically, the silicone rubber layer 92 may be formed from, for example, an ultraviolet-curable liquid silicone rubber available from Shin-Etsu Chemical Co., Ltd. (product name: X-34-4184-A/B).

The silicone rubber layer 92 is thicker than the silicone rubber layer 93, for example, about 500 μm thick.

The silicone rubber layer 93 forms the side surface 27b of the recessed area 27. As described above, the height difference δ can be adjusted by changing the thickness of the silicone rubber layer 93. The silicone rubber layer 93 has a thickness of, for example, about several to ten micrometers, which is set as appropriate depending on the height difference δ of the printing plate 25.

The silicone rubber layer 93 is disposed on the surface 92a of the silicone rubber layer 92 and may be formed from polydimethylsiloxane (PDMS), as is the silicone rubber layer 92. The silicone rubber layer 93 is a layer different from the silicone rubber layer 92 and forms the side surface 27b of the recessed area 27, as described above. Thus, the silicone rubber layer 93 is preferably formed from a material that can be patterned. For example, the silicone rubber layer 93 is formed from an ultraviolet-curable polydimethylsiloxane (PDMS) or a thermosetting polydimethylsiloxane (PDMS). The ultraviolet-curable polydimethylsiloxane (PDMS) can be either of a type that cures in a region irradiated with ultraviolet light or of a type that softens in a region irradiated with ultraviolet light, depending on the method of manufacture.

For example, the ultraviolet-curable polydimethylsiloxane (PDMS) may be an ultraviolet-curable liquid silicone rubber available from Shin-Etsu Chemical Co., Ltd. (product name: X-34-4184-A/B). Other examples include KE106 (product name), X-32-3279 (prototype No.), and X-32-3094-2 (prototype No.) available from Shin-Etsu Chemical Co., Ltd., which are of two-component room-temperature curable type.

The silicone rubber layer 92 preferably has a thickness of from 10 μm to 1 mm. Too thin a silicone rubber layer 92, i.e., having a thickness of less than 10 μm, is not preferred since the rate of absorption of the solvent from the printing ink would decrease. On the other hand, too thick a silicone rubber layer 92, i.e., having a thickness of more than 1 mm, is not preferred since such a silicone rubber layer 92 would deform noticeably when exposed to a stress during printing, which results in decreased dimensional reproducibility and alignment accuracy. The rate of absorption vₛ of the solvent from the printing ink, described later, varies greatly with the solvent in the printing ink used, and the lower limit of the preferred thickness of the silicone rubber layer 92 varies accordingly.

The fluorine compound layer 94 of the printing plate 25 forms the non-image area 25b.

In addition to liquid repellency to the printing ink, as described later, the fluorine compound layer 94 preferably exhibits high adhesion to the surface 93a of the silicone rubber layer 93. In addition, the fluorine compound layer 94 preferably has low fragility so that the fluorine compound layer 94 does not crack when exposed to a load due to the printing pressure, which is, for example, about 10 kPa to 1 MPa, during printing. Thus, the fluorine compound layer 94 is preferably formed of a polymer containing a fluoroalkyl group as a main component. If the fluorine compound layer 94 has poor adhesion to the surface 93a of the silicone rubber layer 93, an adhesive layer can be provided as an interlayer.

More specifically, the fluorine compound layer 94 may be formed from, for example, Durasurf (registered trademark) (DS-5210TH (product name)) available from Harves Co., Ltd. or Optool (registered trademark) DSX (product name) available from Daikin Industries, Ltd. As described above, the fluorine compound layer 94 preferably has a thickness of from 1 nm to 100 nm.

Liquid repellency to a printing ink and liquid receptivity to a printing ink can be evaluated as follows.

Liquid repellency and liquid receptivity are evaluated from the behavior of droplets deposited on the boundary between a region expected to be liquid-repellent and a region expected to be liquid-receptive. A region where the droplet volume has decreased relative to the droplet volume upon deposition is determined to be an ink-repellent area having liquid repellency, whereas a region where the droplet volume has increased relative to the droplet volume upon deposition is determined to be an ink-receptive area having liquid receptivity.

Liquid repellency and liquid receptivity are imparted during the process of plate fabrication. In this case, liquid repellency and liquid receptivity are evaluated from the behavior of droplets deposited on the boundary between an ink-repellent area that is liquid-repellent and an ink-receptive area that is liquid-receptive. A region where the droplet volume has decreased relative to the droplet volume upon deposition is determined to be liquid-repellent, whereas a region where the droplet volume has increased relative to the droplet volume upon deposition is determined to be liquid-receptive.

If the advancing contact angle of a printing ink on the image area 25a is denoted by θ_{A,s} and the receding contact angle of the printing ink on the non-image area 25b is denoted by θ_{R,f}, the receding contact angle θ_{R,f} of the printing ink on the non-image area 25b is preferably larger than the advancing contact angle θ_{A,s} of the printing ink on the image area 25a. More preferably, the difference between the receding contact angle θ_{R,f} and the advancing contact angle θ_{A,s} is 10° or more. If the difference is 10° or more, there is a distinct difference between the liquid receptivity of the image area 25a and the liquid repellency of the non-image area 25b to the printing ink, thus allowing the formation of a high-resolution pattern.

If the receding contact angle θ_{R,f} of the printing ink on the non-image area 25b is larger than the advancing contact angle θ_{A,s} of the printing ink on the image area 25a, the printing ink present on the boundary therebetween moves from the ink-repellent area (non-image area 25b), which is liquid-repellent, to the ink-receptive area (image area 25a), which is liquid-receptive.

Theoretically, the force F acting on the printing ink present on the boundary between the image area 25a and the non-image area 25b in the direction from the non-image area 25b toward the image area 25a is expressed by the following equation:

F=−γπr(cos θ_{R},f−cos θ_{A,s})

where γ is the surface tension of the printing ink, and r is the radius of the contact surface of the droplet.

Assuming that the receding contact angle θ_{R,f} and the advancing contact angle θ_{A,s} are less than 180° (all droplets satisfy this condition), if θ_{R,f}>θ_{A,s}, F is positive, and the droplet moves to the image area 25a side. In addition, friction occurs between the printing ink and the plate surface; therefore, in practice, it is more preferable that the difference between the receding contact angle θ_{R,f} and the advancing contact angle θ_{A,s} be 10° or more.

Advancing contact angle and receding contact angle can be measured by the tilting-plate method (also known as the sliding method), the Wilhelmy method, or the extension/contraction method. In the present invention, advancing contact angle and receding contact angle were measured by the tilting-plate method (also known as the sliding method).

Preferably, the printing ink contains a solvent, and the rate of absorption of the solvent into the image area 25a is higher than the rate of absorption of the same solvent into the non-image area 25b. That is, v_{f}<vₛ is preferred, where vₛ is the rate of absorption of the solvent into the image area 25a, and v_{f} is the rate of absorption of the solvent into the non-image area 25b. This reduces the spreading of the printing ink on the image area 25a during the transfer of the printing ink, thus allowing the formation of a high-resolution pattern.

The rate of absorption vₛ of the solvent from the printing ink into the image area 25a is preferably 0.1 μm/s or more, more preferably 1.0 μm/s or more. The rate of absorption v_{f} of the solvent from the printing ink into the non-image area 25b is preferably less than 0.1 μm/s, more preferably less than 0.01 μm/s.

The advancing contact angle and the receding contact angle can be adjusted by adding a surfactant to the solvent for the printing ink.

The rate of absorption of the solvent from the printing ink will be described. The rate of absorption of the solvent from the printing ink is determined as follows. Droplets of the printing ink are first deposited on an image area and a non-image area by an inkjet process, and images of the shapes of the deposited droplets of the printing ink are captured exactly from the side thereof by a camera. The amount of ink remaining on the image area and the non-image area is calculated by processing images of the shapes of the ink droplets captured at time intervals after deposition. The amount of ink is differentiated with respect to time to give the rate of absorption and the rate of evaporation of the solvent from the printing ink.

To take into account the influence of the evaporation of the solvent from the printing ink, a Si wafer having formed thereon a liquid-repellent layer equivalent to the non-image area is provided. An experiment is performed in the same manner as the experiment on the image area and the non-image area, and the rate of evaporation of the solvent from the printing ink is calculated. Since the absorption of the solvent into the Si wafer is negligible, only the evaporation of the solvent from the printing ink is considered.

The rate of absorption of the solvent from the printing ink can be obtained by subtracting the rate of evaporation obtained using the Si wafer from the sum of the rate of absorption and the rate of evaporation.

Here, the desired amount of fluorine compound applied to the non-image area 25b is comprehensively determined from the thickness of the fluorine compound layer 94 of the printing plate 25, the receding contact angle θ_{R,f}, the advancing contact angle θ_{A,s}, and the rate of absorption vₛ of the solvent from the printing ink. However, the desired amount of fluorine compound applied to the non-image area 25b can be estimated from the ratio of the amount of fluorine compound to the amount of PDMS-derived component determined by time-of-flight secondary ion mass spectrometry (TOF-SIMS), that is, the F/Si ratio, which has a positive correlation with receding contact angle θ_{R,f} and liquid repellency, as described later. As described in detail later, a F/Si ratio of 1689.75 or more results in a large receding contact angle θ_{R,f} and therefore good liquid repellency. Thus, the F/Si ratio is preferably 1689.75 or more.

F/Si ratio=[C₃OF₇]/([Si₃O₇H]+[Si₃C₅H₁₅O₄])

where [C₃OF₇] is the number of counts at a mass-to-charge ratio m/z of 184.98, [Si₃O₇H] is the number of counts at a mass-to-charge ratio m/z of 196.90, and [Si₃C₅H₁₅O₄] is the number of counts at a mass-to-charge ratio m/z of 223.03.

A first example method for manufacturing the printing plate 25 will be described next.

FIGS. 11 to 15 are schematic sectional views showing, in sequence, the steps of the first example method for manufacturing the printing plate 25. In FIGS. 11 to 15, components identical to those of the printing plate 25 shown in FIG. 7 are denoted by the same reference numerals, and a detailed description thereof is omitted.

As shown in FIG. 11, a support 90 having a silicone rubber layer 92 serving as a first layer containing silicone rubber is provided first. The silicone rubber layer 92 is formed from an ultraviolet-curable PDMS or a thermosetting PDMS as described above.

A photocurable PDMS is then applied to the silicone rubber layer 92 to form a silicone rubber layer 100. The photocurable PDMS is, for example, an ultraviolet-curable PDMS as described above. The silicone rubber layer 100 cures in a region irradiated with ultraviolet light Lv. The ultraviolet light Lv is obtained from a common ultraviolet exposure apparatus used for semiconductor manufacturing apparatuses. To break chemical bonds such as those of the fluorine compound, the ultraviolet light Lv is preferably light with a wavelength of 300 nm or less.

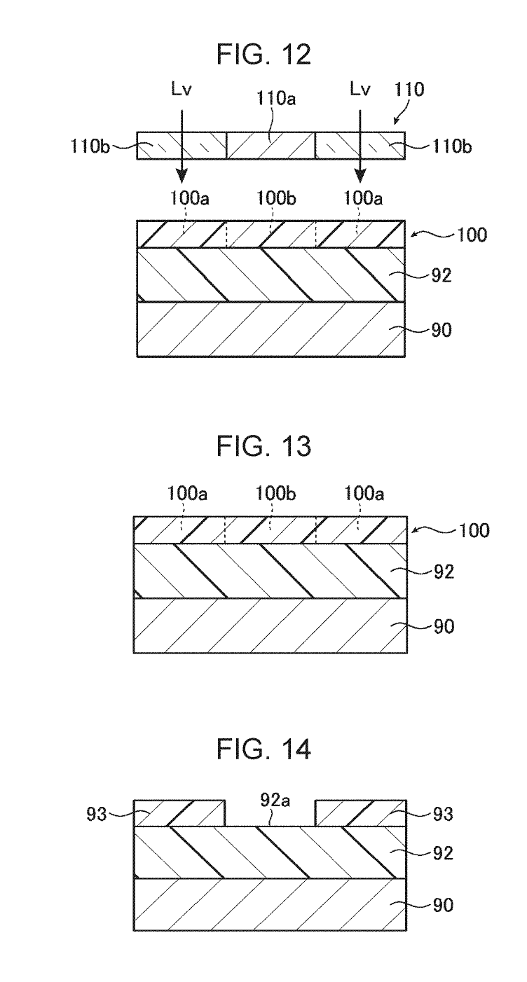

As shown in FIG. 12, a mask 110 is then placed over the silicone rubber layer 100. The mask 110 allows the ultraviolet light Lv to pass through the region other than a chromium layer 110a. A region 110b that allows the ultraviolet light Lv to pass therethrough is formed in the pattern of the non-image area 25b, whereas the chromium layer 110a is formed in the pattern of the image area 25a.

The silicone rubber layer 100 is then irradiated with the ultraviolet light Lv through the mask 110. Upon irradiation with the ultraviolet light Lv, the irradiated region 100a of the silicone rubber layer 100 cures, whereas the unirradiated region 100b does not cure. The unirradiated region 100b is a region that becomes the image area 25a.

The mask 110 is then removed from over the silicone rubber layer 100. As shown in FIG. β, the silicone rubber layer 100 after irradiation with the ultraviolet light Lv is post-baked, for example, in an atmosphere at room temperature for a predetermined period of time. Post-baking promotes the curing of the silicone rubber layer 100.

After post-baking, the silicone rubber layer 100 is subjected to development treatment, for example, with toluene, to dissolve and remove the unirradiated region 100b. As shown in FIG. 14, a portion of the surface 92a of the silicone rubber layer 92 is exposed, and a silicone rubber layer 93 serving as a second layer containing silicone rubber is formed in the region that becomes the non-image area 25b on the surface 92a of the silicone rubber layer 92.

In the first example method for manufacturing the printing plate 25, the technique using an ultraviolet-curable PDMS as described above need not be employed to form an intaglio-plate-shaped layer containing silicone rubber in which the image area 25a is a recessed area, like the silicone rubber layers 92 and 93 shown in FIG. 14; instead, a technique in which a thermosetting PDMS is cast by pouring it onto a template may be employed, as employed to form the raised area 92b of the silicone rubber layer 92 shown in FIG. 8. Examples of materials for the template used include glass, metal, Si, and resist. “Resist” refers to a patterned resist layer on a glass or other substrate.

A template having a multistep raised and recessed structure can be used to form a silicone rubber layer 93 whose thickness changes stepwise, that is, a recessed area 27 whose depth changes stepwise, in the plane of the printing plate 25. This technique further broadens the range of amounts of printing ink applied, described later.

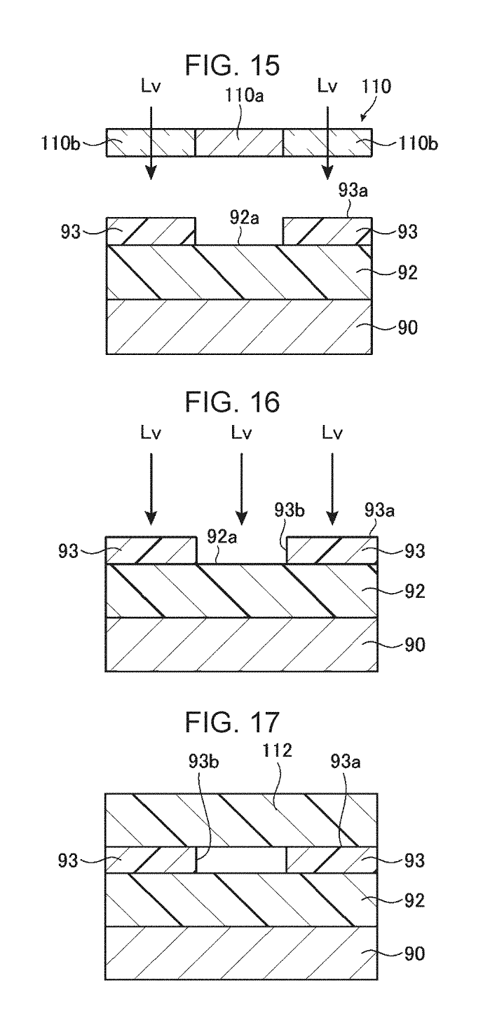

As shown in FIG. 15, the mask 110 is then placed over the silicone rubber layer 93 such that the region 110b that allows the ultraviolet light Lv to pass therethrough is aligned with the surface 93a of the silicone rubber layer 93, and the surface 93a of the silicone rubber layer 93 is irradiated with the ultraviolet light Lv. The irradiation with the ultraviolet light Lv forms hydroxyl groups on the surface 93a of the silicone rubber layer 93, thereby activating the surface 93a. The mask 110 is then removed from over the silicone rubber layer 93.

The activated surface 93a of the silicone rubber layer 93 is then subjected to silane coupling treatment, for example, by immersing the silicone rubber layer 93 together with the support 90 in a silane coupling agent (not shown). Thereafter, any unreacted silane coupling agent is removed by spinning on a spin coater, and the silane coupling agent is fixed to the activated surface 93a, for example, in a saturated water vapor pressure environment at a predetermined temperature for a predetermined period of time.

The silane coupling agent is, for example, a primer intended for Durasurf (DS-PC-3B (model No.)).

A fluorine compound (not shown) is then applied to the surface 93a of the silicone rubber layer 93 and is fixed at a predetermined temperature for a predetermined period of time. Thereafter, any unfixed fluorine compound is cleaned off, for example, by spin coating with a fluorinated solvent (Durasurf (DS-TH (product name)) available from Harves Co., Ltd.). Thus, the intaglio printing plate 25 shown in FIG. 7 can be obtained. The fluorine compound is, for example, Durasurf (DS-5210TH (product name)) available from Harves Co., Ltd. or Optool (registered trademark) DSX (product name) available from Daikin Industries, Ltd.

In the silane coupling treatment, it is desirable to start immersion in the silane coupling agent immediately after exposure, specifically, within 30 seconds after exposure. This is because surface radicals formed on the surface of the irradiated region by the exposure treatment deactivate within a short period of time and also because the surface of the irradiated region gradually returns to a hydrophobic surface as the uncrosslinked component bleeds from the silicone rubber layer 93.

Although the activated surface 93a is formed by a mask exposure process using the mask 110, the activated surface 93a need not be formed by this process, but may instead be formed by plasma treatment using a mask having an opening or by a direct imaging process in which a laser or focused light beam is directly scanned.

Although the activated surface 93a is subjected to silane coupling treatment by a liquid-phase process in which the activated surface 93a is immersed in a silane coupling agent, the silane coupling treatment need not be performed by this process, but may instead be performed on the activated surface 93a using the silane coupling agent in gaseous form.

If the image area 25a is insufficiently activated, the surface 92a of the silicone rubber layer 92 and the side surface 93b of the silicone rubber layer 93 can be further activated by chemical or physical treatment.

Although the fluorine compound is applied after silane coupling treatment in the foregoing method for manufacturing the printing plate 25, this technique need not be employed. For example, a fluorine-containing silane coupling agent may be bound to the hydroxyl groups by a gas-phase process or a liquid-phase process during silane coupling treatment to form the fluorine compound layer 94 (see FIG. 7).

A second example method for manufacturing the printing plate 25 will be described next.

FIGS. 16 and 17 are schematic sectional views showing, in sequence, the steps of the second example method for manufacturing the printing plate 25. In FIGS. 16 and 17, components identical to those of the printing plate 25 shown in FIG. 7 are denoted by the same reference numerals, and a detailed description thereof is omitted.

As shown in FIG. 14, the silicone rubber layer 93 is formed on the silicone rubber layer 92. As shown in FIG. 16, the silicone rubber layer 92 is irradiated with the ultraviolet light Lv together with the surface 93a of the silicone rubber layer 93 to form hydroxyl groups over the entire surface 93a of the silicone rubber layer 93, thereby activating the surface 93a of the silicone rubber layer 93. In this case, the surface 92a of the silicone rubber layer 92 is also activated. The side surface 93b of the silicone rubber layer 93 is also activated if the side surface 93b is irradiated with the ultraviolet light Lv.

In the second example method for manufacturing the printing plate 25, the technique using an ultraviolet-curable PDMS as described above need not be employed to form an intaglio-plate-shaped layer containing silicone rubber in which the image area 25a is a recessed area, like the silicone rubber layers 92 and 93 shown in FIG. 14; instead, a technique in which a thermosetting PDMS is cast by pouring it onto a template may be employed, as employed to form the silicone rubber layer 92 and the raised area 92b of the silicone rubber layer 92 shown in FIG. 8. Examples of materials for the template used are as listed above.

As shown in FIG. 17, the surface 93a of the silicone rubber layer 93 is then subjected to silane coupling treatment, for example, by pressing a substrate 112 containing a silane coupling agent into contact with only the surface 93a of the silicone rubber layer 93. Thereafter, the fluorine compound layer 94 (see FIG. 7) is formed on the surface 93a subjected to silane coupling treatment. The fluorine compound layer 94 may be formed as described above. The substrate 112 containing the silane coupling agent can be formed by immersing a base material for the substrate 112 in a solution of the silane coupling agent for a predetermined period of time. The base material for the substrate 112 may be any material that absorbs the silane coupling agent and the solvent therefor, for example, PDMS. The period of time during which the base material is immersed in the solution of the silane coupling agent may be appropriately determined depending on the silane coupling agent concentration and the rate of absorption of the solvent into the base material.

The technique described above need not be employed. For example, the fluorine compound layer 94 may instead be formed on the surface 93a of the silicone rubber layer 93 by pressing a substrate 112 containing a fluorine-containing silane coupling agent into contact with only the surface 93a of the silicone rubber layer 93. The base material for the substrate 112 is formed of, for example, PDMS, SHIN-ETSU SIFEL (registered trademark) available from Shin-Etsu Chemical Co., Ltd., or DAI-EL (registered trademark) available from Daikin Industries, Ltd.

The technique described above need not be employed. For example, the surface 92a of the silicone rubber layer 92 and the surface 93a of the silicone rubber layer 93 are subjected to silane coupling treatment by immersion in a silane coupling agent. The silane coupling treatment may be performed as described above. Thereafter, as shown in FIG. 17, the fluorine compound layer 94 (see FIG. 7) is formed, for example, by pressing a substrate 112 containing a fluorine compound into contact with only the surface 93a subjected to silane coupling treatment. Thus, the intaglio printing plate 25 shown in FIG. 7 can be obtained. The configuration of the base material for the substrate 112 is as described above.

A third example method for manufacturing the printing plate 25 will be described next.

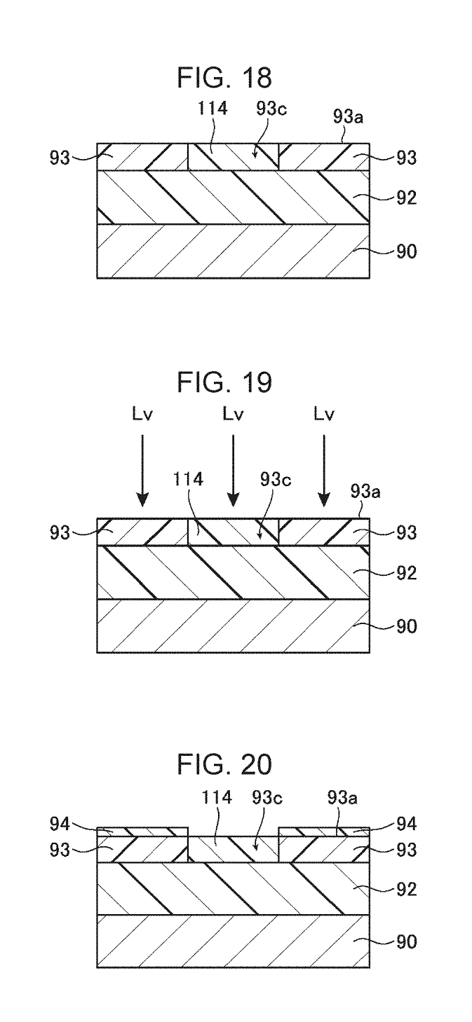

FIGS. 18 to 21 are schematic sectional views showing, in sequence, the steps of the third example method for manufacturing the printing plate 25. In FIGS. 18 to 21, components identical to those of the printing plate 25 shown in FIG. 7 are denoted by the same reference numerals, and a detailed description thereof is omitted.

As shown in FIG. 14, the silicone rubber layer 93 is formed on the silicone rubber layer 92. As shown in FIG. 18, the recessed area 93c of the silicone rubber layer 93 is filled with a resist to form a resist layer 114. The resist may be any resist that can be used to form the resist layer 114 on the silicone rubber layer 92, and known resists can be used as appropriate.

In the third example method for manufacturing the printing plate 25, the technique using an ultraviolet-curable PDMS as described above need not be employed to form an intaglio plate shape from silicone rubber, like the silicone rubber layers 92 and 93 shown in FIG. 14; instead, a technique in which a thermosetting PDMS is cast by pouring it onto a template may be employed, as employed to form the silicone rubber layer 92 and the raised area 92b of the silicone rubber layer 92 shown in FIG. 8. Examples of materials for the template used are as listed above.

The resist layer 114 also preferably has low transmittance for the ultraviolet light Lv, that is, high absorbance for the ultraviolet light Lv. This reduces the exposure of the portion covered by the resist layer 114 to the ultraviolet light Lv.

As shown in FIG. 19, the surface 93a of the silicone rubber layer 93 is then irradiated with the ultraviolet light Lv together with the resist layer 114. Thus, hydroxyl groups are formed on the surface 93a of the silicone rubber layer 93, thereby activating the surface 93a.

The activated surface 93a is then subjected to silane coupling treatment. Thereafter, as shown in FIG. 20, the fluorine compound layer 94 is formed on the surface 93a subjected to silane coupling treatment. The silane coupling treatment is performed as described above; therefore, a detailed description thereof is omitted. The fluorine compound layer 94 is formed in the same manner as the fluorine compound layer 94 described above.

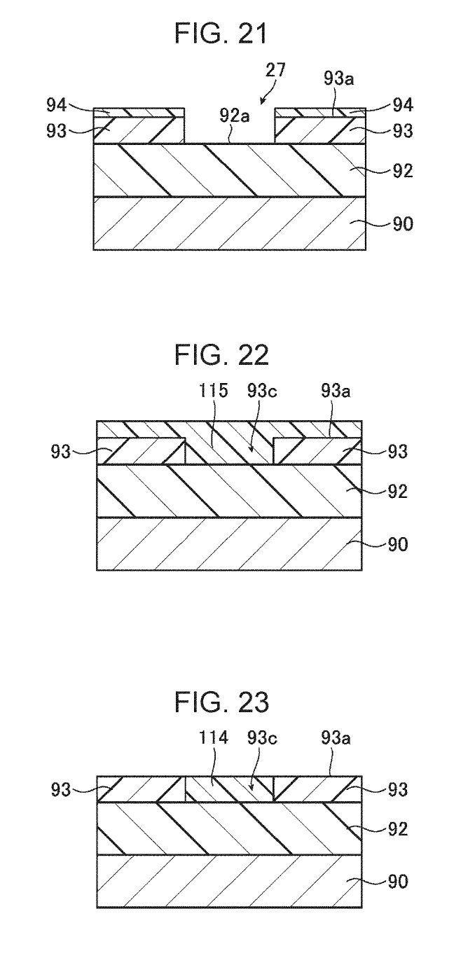

As shown in FIG. 21, the resist layer 114 is then removed. To remove the resist layer 114, known techniques for removing the resist layer 114 that are employed in photolithography can be employed as appropriate. For example, the resist layer 114 is removed by dissolving the resist layer 114 in a solvent. Thus, the printing plate 25 shown in FIG. 7 can be obtained.

A fourth example method for manufacturing the printing plate 25 will be described next.

FIGS. 22 to 25 are schematic sectional views showing, in sequence, the steps of the fourth example method for manufacturing the printing plate 25. In FIGS. 22 to 25, components identical to those of the printing plate 25 shown in FIG. 7 are denoted by the same reference numerals, and a detailed description thereof is omitted.

As shown in FIG. 14, the silicone rubber layer 93 is formed on the silicone rubber layer 92. As shown in FIG. 22, a resist is used to form a resist layer 115 filling the recessed area 93c of the silicone rubber layer 93 and covering the surface 93a of the silicone rubber layer 93. The resist may be any resist that can be used to form the resist layer 115 on the silicone rubber layer 92, and known resists can be used as appropriate. The resist layer 115 may be formed of the same resist as the resist layer 114.

In the fourth example method for manufacturing the printing plate 25, the technique using an ultraviolet-curable PDMS as described above need not be employed to form an intaglio plate shape from silicone rubber, like the silicone rubber layers 92 and 93 shown in FIG. 14; instead, a technique in which a thermosetting PDMS is cast by pouring it onto a template may be employed, as employed to form the silicone rubber layer 92 and the raised area 92b of the silicone rubber layer 92 shown in FIG. 8. Examples of materials for the template used are as listed above.

As shown in FIG. 23, the surface 93a of the silicone rubber layer 93 is then exposed, for example, by dry-etching or wet-etching the resist layer 115, thereby forming a resist layer 114 only in the recessed area 93c of the silicone rubber layer 93.

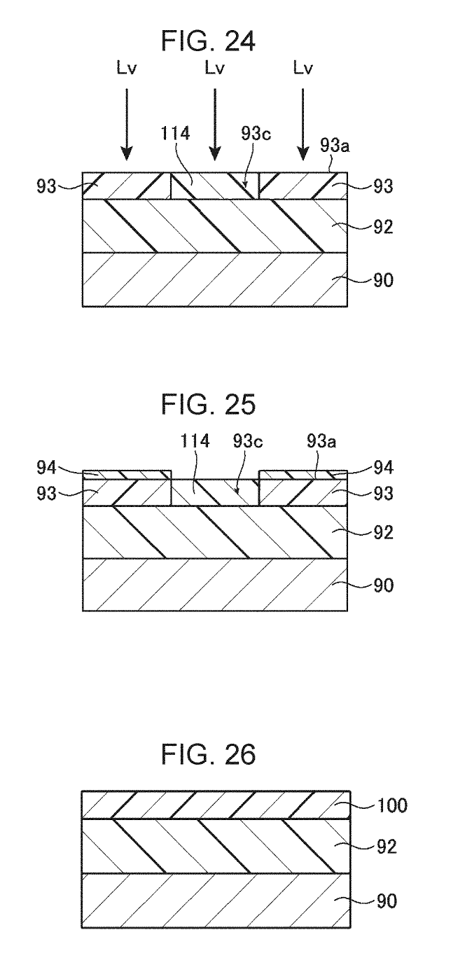

As shown in FIG. 24, the surface 93a of the silicone rubber layer 93 is then irradiated with the ultraviolet light Lv together with the resist layer 114. Thus, hydroxyl groups are formed on the surface 93a of the silicone rubber layer 93, thereby activating the surface 93a.

The activated surface 93a is then subjected to silane coupling treatment. Thereafter, as shown in FIG. 25, the fluorine compound layer 94 is formed on the surface 93a subjected to silane coupling treatment. The silane coupling treatment is performed as described above; therefore, a detailed description thereof is omitted. The fluorine compound layer 94 is formed in the same manner as the fluorine compound layer 94 described above.

The resist layer 114 is then removed. To remove the resist layer 114, as described above, known techniques for removing the resist layer 114 that are employed in photolithography can be employed as appropriate. For example, the resist layer 114 is removed by dissolving the resist layer 114 in a solvent. Thus, the printing plate 25 shown in FIG. 7 can be obtained.

A fifth example method for manufacturing the printing plate 25 will be described next.

FIGS. 26 to 29 are schematic sectional views showing, in sequence, the steps of the fifth example method for manufacturing the printing plate 25. In FIGS. 26 to 29, components identical to those of the printing plate 25 shown in FIG. 7 are denoted by the same reference numerals, and a detailed description thereof is omitted.

As shown in FIG. 26, a support 90 having a silicone rubber layer 92 is provided first. The silicone rubber layer 92 is formed from, for example, PDMS. A photocurable PDMS is then applied to the silicone rubber layer 92 to form a silicone rubber layer 100. The photocurable PDMS is, for example, an ultraviolet-curable PDMS as described above.

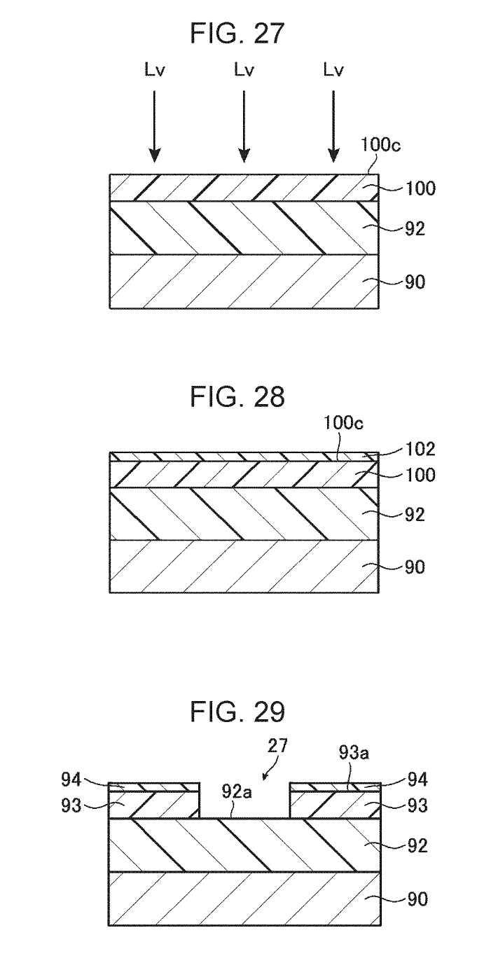

As shown in FIG. 27, the entire surface 100c of the silicone rubber layer 100 is then irradiated with ultraviolet light Lv to form hydroxyl groups over the entire surface 100c of the silicone rubber layer 100, thereby activating the surface 100c.

The activated surface 100c of the silicone rubber layer 100 is then subjected to silane coupling treatment. As shown in FIG. 28, a fluorine compound layer 102 is then formed over the entire surface 100c of the silicone rubber layer 100. The silane coupling treatment is performed as described above; therefore, a detailed description thereof is omitted. The fluorine compound layer 102 is formed in the same manner as the fluorine compound layer 94 described above; therefore, a detailed description thereof is omitted.

The fluorine compound layer 102 and the silicone rubber layer 100 are then patterned to remove the fluorine compound layer 102 and the silicone rubber layer 100 from the region that becomes the image area 25a. As shown in FIG. 29, a recessed area 27 in which the surface 92a of the silicone rubber layer 92 is exposed is formed. Thus, the printing plate 25 shown in FIG. 7 can be obtained.

A sixth example method for manufacturing the printing plate 25 will be described next.

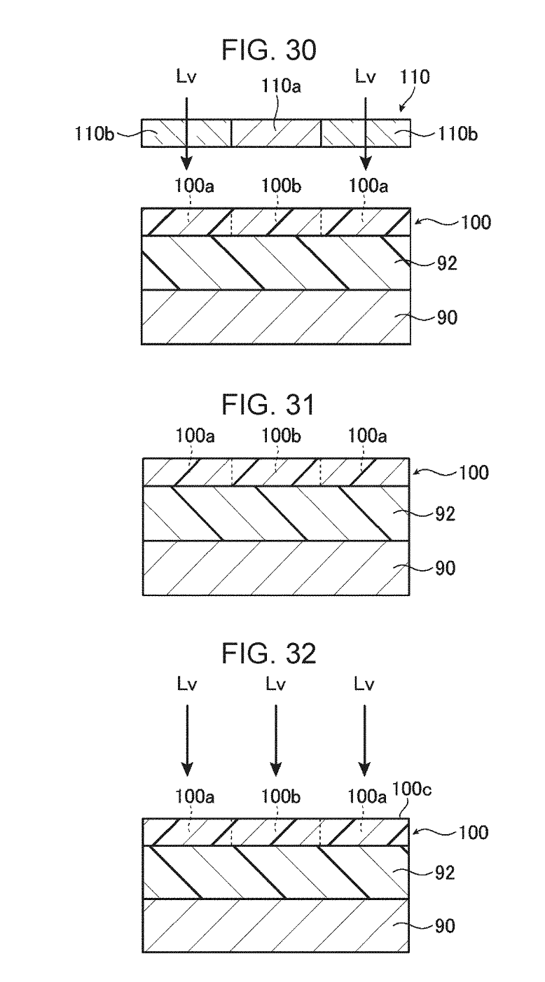

FIGS. 30 to 34 are schematic sectional views showing, in sequence, the steps of the sixth example method for manufacturing the printing plate 25. In FIGS. 30 to 34, components identical to those of the printing plate 25 shown in FIG. 7 are denoted by the same reference numerals, and a detailed description thereof is omitted.

As shown in FIG. 26, the silicone rubber layer 100 is formed on the silicone rubber layer 92. As shown in FIG. 30, for example, a mask 110 in which a region 110b that allows ultraviolet light Lv to pass therethrough is formed in the pattern of the non-image area 25b and a chromium layer 110a is formed in the pattern of the image area 25a is placed over the silicone rubber layer 100. The silicone rubber layer 100 is then irradiated with the ultraviolet light Lv through the mask 110. Upon irradiation with the ultraviolet light Lv, the irradiated region 100a of the silicone rubber layer 100 cures, whereas the unirradiated region 100b does not cure. The unirradiated region 100b is a region that becomes the image area 25a.

The mask 110 is then removed from over the silicone rubber layer 100. As shown in FIG. 31, the silicone rubber layer 100 after irradiation with the ultraviolet light Lv is post-baked to promote curing, for example, in an atmosphere at room temperature for a predetermined period of time.

After post-baking, as shown in FIG. 32, the entire surface 100c of the silicone rubber layer 100 is irradiated with ultraviolet light Lv to form hydroxyl groups over the entire surface 100c of the silicone rubber layer 100, thereby activating the surface 100c.

The wavelength and illuminance of the ultraviolet light Lv used in the step of irradiating the silicone rubber layer 100 with the ultraviolet light Lv through the mask 110 to cure the irradiated region 100a of the silicone rubber layer 100 may be the same as or different from those of the ultraviolet light Lv used in the step of irradiating the entire surface 100c of the silicone rubber layer 100 with the ultraviolet light Lv. The wavelength and illuminance of the ultraviolet light Lv may be any wavelength and illuminance that allow it to cure the silicone rubber layer 100 or activate the surface 100c of the silicone rubber layer 100 in each step.

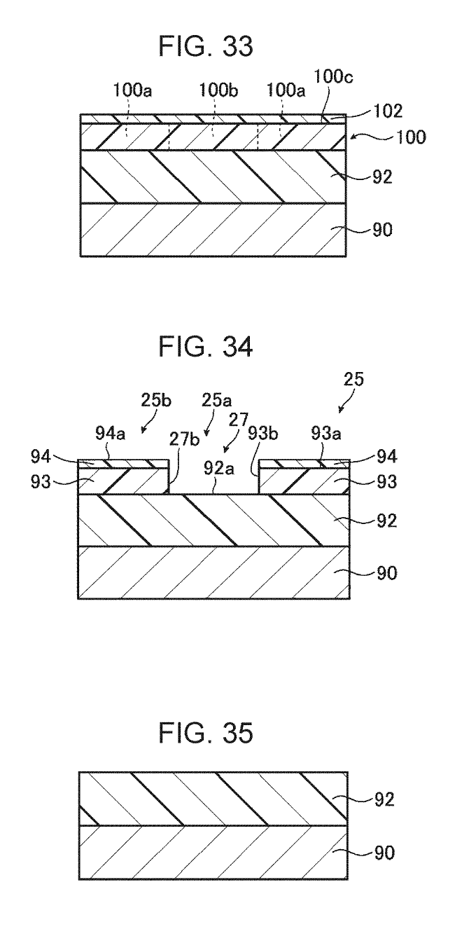

The activated surface 100c of the silicone rubber layer 100 is then subjected to silane coupling treatment. As shown in FIG. 33, a fluorine compound layer 102 is then formed over the entire surface 100c of the silicone rubber layer 100. The silane coupling treatment is performed as described above; therefore, a detailed description thereof is omitted. The fluorine compound layer 102 is formed in the same manner as the fluorine compound layer 94 described above; therefore, a detailed description thereof is omitted.

The fluorine compound layer 102 is then patterned to expose the unirradiated region 100b. The silicone rubber layer 100 is then subjected to development treatment, for example, with toluene, to dissolve and remove the unirradiated region 100b of the silicone rubber layer 100. Thus, as shown in FIG. 34, a recessed area 27 in which the surface 92a of the silicone rubber layer 92 is exposed is formed, and the printing plate 25 can be obtained.

A seventh example method for manufacturing the printing plate 25 will be described next.

FIGS. 35 to 39 are schematic sectional views showing, in sequence, the steps of the seventh example method for manufacturing the printing plate 25. In FIGS. 35 to 39, components identical to those of the printing plate 25 shown in FIG. 8 are denoted by the same reference numerals, and a detailed description thereof is omitted.

As shown in FIG. 35, a support 90 having a silicone rubber layer 92 is provided first.

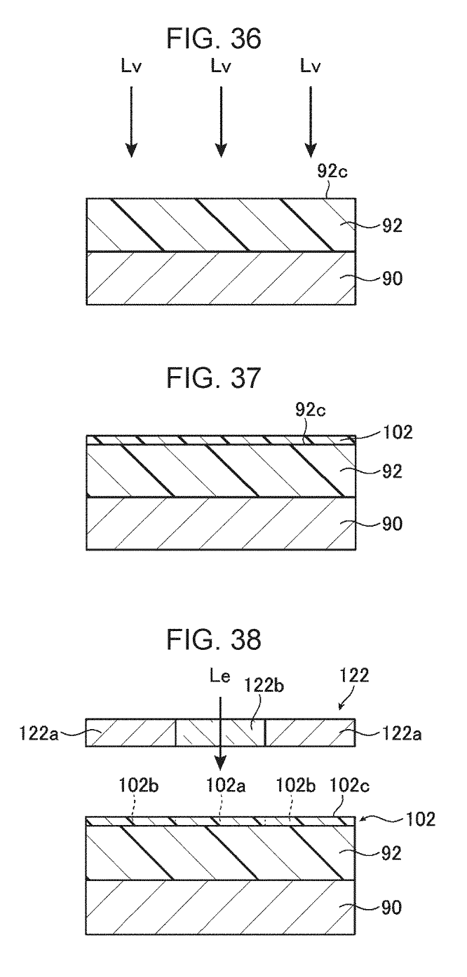

As shown in FIG. 36, the entire outermost surface 92c of the silicone rubber layer 92 is then irradiated with ultraviolet light Lv to form hydroxyl groups over the entire outermost surface 92c of the silicone rubber layer 92, thereby activating the outermost surface 92c of the silicone rubber layer 92.

The entire activated outermost surface 92c of the silicone rubber layer 92 is then subjected to silane coupling treatment. As shown in FIG. 37, a fluorine compound layer 102 is then formed over the entire outermost surface 92c of the silicone rubber layer 92. The silane coupling treatment is performed as described above; therefore, a detailed description thereof is omitted. The fluorine compound layer 102 is formed in the same manner as the fluorine compound layer 94 described above; therefore, a detailed description thereof is omitted.

As shown in FIG. 38, a mask 122 is then placed over the surface 102c of the fluorine compound layer 102. The mask 122 allows laser light Le emitted from, for example, an excimer laser to pass through the region other than a chromium layer 122a. The chromium layer 122a is formed in the region other than a region 122b corresponding to the recessed area 27.

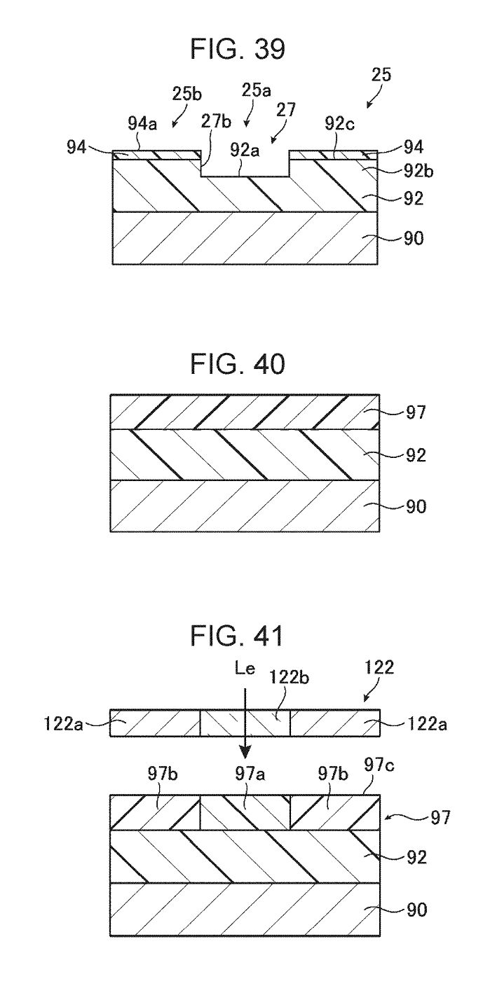

The fluorine compound layer 102 is then irradiated with the laser light Le through the mask 122. Upon irradiation with the laser light Le, the irradiated region 102a of the fluorine compound layer 102 is etched and removed together with the underlying silicone rubber layer 92, whereas the unirradiated region 102b is not etched and removed. Thus, as shown in FIG. 39, the recessed area 27 is formed, and the printing plate 25 is obtained. The irradiated region 102a is a region that becomes the image area 25a.

Although the seventh example method for manufacturing the printing plate 25 uses the mask 122 that allows the laser light Le to pass therethrough, the mask 122 need not be used; instead, the recessed area 27 can be formed by irradiating only the region 122b corresponding to the recessed area 27 with an excimer laser without using the mask 122. The laser light Le need not be emitted from an excimer laser; instead, a high-illuminance laser can be used to cause ablation, thereby forming the recessed area 27. The high-illuminance laser, which is a laser that has an illuminance comparable to that of an excimer laser, need not be a gas laser such as an excimer laser, but may instead be a solid-state laser or a semiconductor laser.

Instead of using the mask 122 that allows the laser light Le to pass therethrough, the following technique can be employed. A metal mask having an opening for the region 122b corresponding to the recessed area 27 is first placed over the surface 102c of the fluorine compound layer 102. The surface 102c of the fluorine compound layer 102 is then etched by plasma treatment with a gas mixture of fluorine and oxygen to obtain the printing plate 25 having the recessed area 27 formed thereon as shown in FIG. 39.

An eighth example method for manufacturing the printing plate 25 will be described next.

FIGS. 40 to 42 are schematic sectional views showing, in sequence, the steps of the eighth example method for manufacturing the printing plate 25. In FIGS. 40 to 42, components identical to those of the printing plate 25 shown in FIG. 7 are denoted by the same reference numerals, and a detailed description thereof is omitted.

The printing plate 25 need not have the fluorine compound layer 94 (see FIG. 8) formed on the silicone rubber layer 93, but may instead have a layer containing a fluorosurfactant and a silicone resin. In this case, the fluorine compound layer 94 (see FIG. 8) is not separately formed. As shown in FIG. 40, a support 90 having stacked thereon a silicone rubber layer 92 and a silicone rubber layer 97 containing a fluorosurfactant and a silicone resin is provided.

The silicone rubber layer 97 containing a fluorosurfactant and a silicone resin is, for example, a layer of silicone rubber containing a fluorosurfactant. The silicone rubber is, for example, an ultraviolet-curable PDMS or a thermosetting PDMS as described above. The fluorosurfactant is, for example, Optool (registered trademark) DAC (additive) available from Daikin Industries, Ltd. or the Megaface series available from DIC Corporation.

The silicone rubber layer 97 containing a fluorosurfactant and a silicone resin is hereinafter simply referred to as “silicone rubber layer 97”.

As shown in FIG. 41, a mask 122 that allows laser light Le to pass through the region other than a chromium layer 122a is then placed over the surface 97c of the silicone rubber layer 97. The mask 122 has the same configuration as the mask 122 shown in FIG. 38.

The silicone rubber layer 97 is then irradiated with the laser light Le through the mask 122. Upon irradiation with the laser light Le, the irradiated region 97a of the silicone rubber layer 97 is etched and removed, whereas the unirradiated region 97b is not etched and removed. In this case, the fluorosurfactant present in the silicone rubber layer 97 segregates to the surface 97c of the silicone rubber layer 97. The irradiated region 97a is a region that becomes the image area 25a.

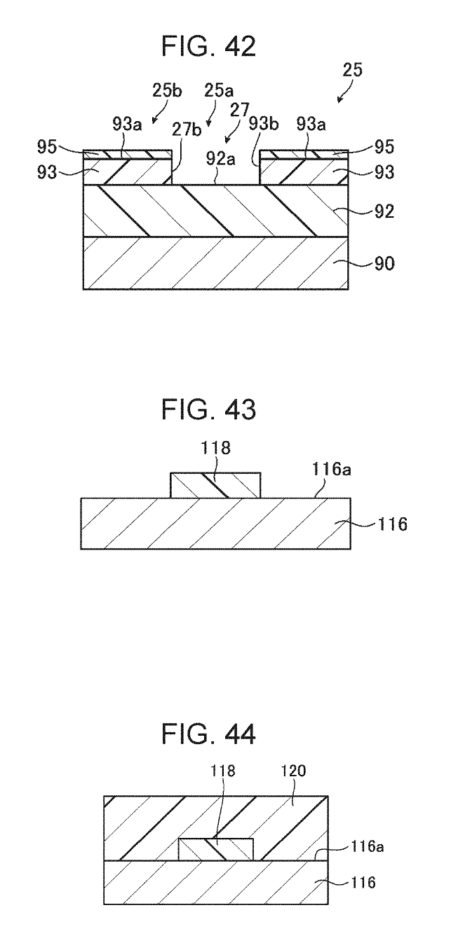

As shown in FIG. 42, a recessed area 27 is formed in the silicone rubber layer 97 to obtain a silicone rubber layer 93. Due to the segregation of the fluorosurfactant to the surface 93a, a fluorine compound 95 is present in the surface 93a of the silicone rubber layer 93. The fluorine compound 95 functions in the same manner as the fluorine compound layer 94 described above. In this way, the printing plate 25 is obtained.

In the eighth example method for manufacturing the printing plate 25, the technique described above need not be employed; instead, the printing plate 25 having the recessed area 27 formed thereon as shown in FIG. 42 may be fabricated by the first example method of manufacture using an ultraviolet-curable PDMS containing a fluorosurfactant as the silicone rubber layer 97.

In this case, as shown in FIG. 12, the mask 110 is first placed over the silicone rubber layer 100, and the silicone rubber layer 100 is irradiated with ultraviolet light Lv through the mask 110. Upon irradiation with the ultraviolet light Lv, the irradiated region 100a of the silicone rubber layer 100 cures, whereas the unirradiated region 100b does not cure. The unirradiated region 100b of the silicone rubber layer 100 is a region that becomes the image area 25a.

The mask 110 is then removed from over the silicone rubber layer 100. As shown in FIG. β, the silicone rubber layer 100 after irradiation with the ultraviolet light Lv is post-baked. After post-baking, the silicone rubber layer 100 is subjected to development treatment. Whereas the irradiated region 100a of the silicone rubber layer 100 is not dissolved and removed, the unirradiated region 100b is dissolved and removed to expose a portion of the surface 92a of the silicone rubber layer 92 (see FIG. 14). Thus, the printing plate 25 having the recessed area 27 formed therein as shown in FIG. 42 is obtained.

A ninth example method for manufacturing the printing plate 25 will be described next.

FIGS. 43 to 48 are schematic sectional views showing, in sequence, the steps of the ninth example method for manufacturing the printing plate 25. In FIGS. 43 to 48, components identical to those of the printing plate 25 shown in FIG. 8 are denoted by the same reference numerals, and a detailed description thereof is omitted.

As shown in FIG. 43, a resist film 118 for forming the recessed area 27 (see FIG. 8) of the printing plate 25 (see FIG. 8) is first formed on a surface 116a of a support 116 to obtain a support 116 having a raised pattern. The resist film 118 has the same configuration and can be formed in the same manner as the resist layer 114 described above; therefore, a detailed description thereof is omitted.

As shown in FIG. 44, a silicone rubber film 120 is then formed over the resist film 118 on the surface 116a of the support 116. The silicone rubber film 120 becomes the silicone rubber layer 92 described above later. Thus, the silicone rubber film 120 has the same thickness and composition and can be formed in the same manner as the silicone rubber layer 92 described above; therefore, a detailed description thereof is omitted. The support 116 is formed of, for example, glass.

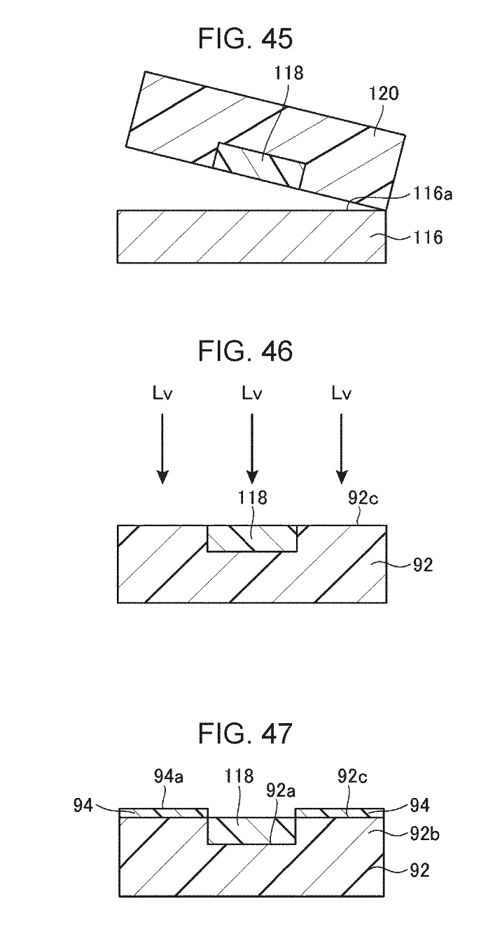

As shown in FIG. 45, the silicone rubber film 120 is then stripped from the support 116. Thus, as shown in FIG. 46, the silicone rubber layer 92 is obtained.

As shown in FIG. 46, the entire outermost surface 92c of the silicone rubber layer 92 is then irradiated with ultraviolet light Lv. In this case, the region filled with the resist film 118, which becomes the recessed area 27 (see FIG. 8) later, is prevented from being irradiated with the ultraviolet light Lv.

The entire outermost surface 92c of the silicone rubber layer 92 filled with the resist film 118 is then subjected to silane coupling treatment. Thereafter, as shown in FIG. 47, a fluorine compound layer 94 is formed on the outermost surface 92c subjected to silane coupling treatment, that is, on the surface of the region that becomes the non-image area.

The silane coupling treatment and the formation of the fluorine compound layer 94 are performed as described above; therefore, a detailed description thereof is omitted.

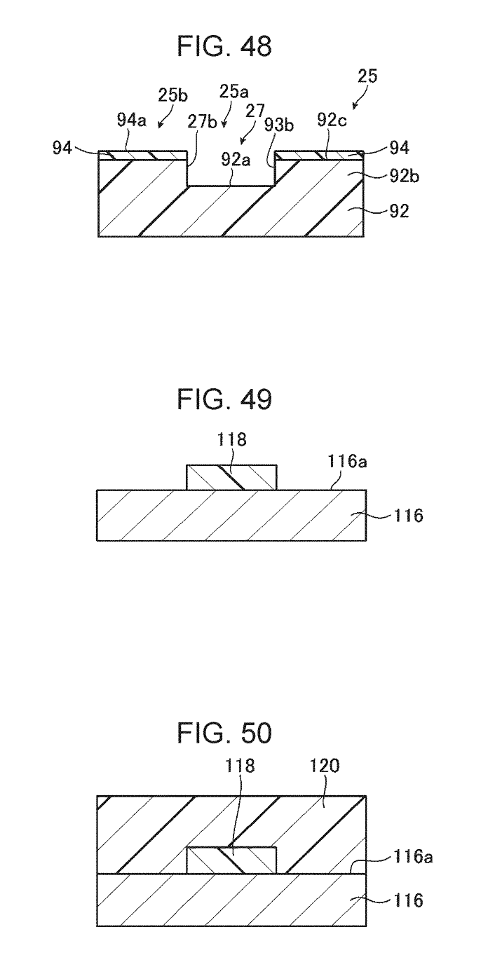

The resist film 118 is then removed. To remove the resist film 118, known techniques for removing resist layers can be employed as appropriate. For example, the resist film 118 can be removed by dissolving the resist film 118 in a solution. Thus, a printing plate 25 shown in FIG. 48 can be obtained.

Although the resist film 118 is formed on the support 116, this configuration need not be used; instead, a template having the shape of the resist film 118 formed thereon may be used as the support 116. In this case, since there is no resist film 118 in the state shown in FIG. 46, it is necessary to perform silane coupling treatment only on the outermost surface 92c of the raised area 92b of the silicone rubber layer 92. Since there is no resist film 118 in the state shown in FIG. 47, it is necessary to form the fluorine compound layer 94 only on the outermost surface 92c of the raised area 92b of the silicone rubber layer 92.

A tenth example method for manufacturing the printing plate 25 will be described next.

FIGS. 49 to 53 are schematic sectional views showing, in sequence, the steps of the tenth example method for manufacturing the printing plate 25. In FIGS. 49 to 53, components identical to those of the printing plate 25 shown in FIG. 8 are denoted by the same reference numerals, and a detailed description thereof is omitted.

As shown in FIG. 49, a resist film 118 having the same shape as the recessed area 27 (see FIG. 8) of the printing plate 25 (see FIG. 8) is first formed on a surface 116a of a support 116 to obtain a support 116 having a raised pattern for forming the recessed area 27 (see FIG. 8) of the printing plate 25 (see FIG. 8). The support 116 having the resist film 118 formed thereon is used as a template for forming the printing plate 25. The resist film 118 has the same configuration and can be formed in the same manner as the resist layer 114 described above; therefore, a detailed description thereof is omitted.

Here, the template shown in FIG. 49 may be subjected to release treatment to improve the release properties after irradiation with ultraviolet light Lv, described later. The release treatment may be performed by known techniques. For example, the release treatment can be completed by cleaning the template and then allowing it to stand in an atmosphere containing a fluorine-containing silane coupling agent, for example, (heptadecafluoro-1,1,2,2-tetrahydrodecyl)triethoxysilane, vaporized at a temperature of 120° C. for two hours. The template may be cleaned by a technique selected as appropriate from oxygen plasma treatment, vacuum ultraviolet irradiation treatment, ozone treatment, and other techniques.

As shown in FIG. 50, a silicone rubber film 120 is then formed over the resist film 118 on the surface 116a of the support 116. The silicone rubber film 120 becomes the silicone rubber layer 92 described above later. Thus, the silicone rubber film 120 has the same thickness and composition and can be formed in the same manner as the silicone rubber layer 92 described above; therefore, a detailed description thereof is omitted. The support 116 is formed of, for example, quartz glass.

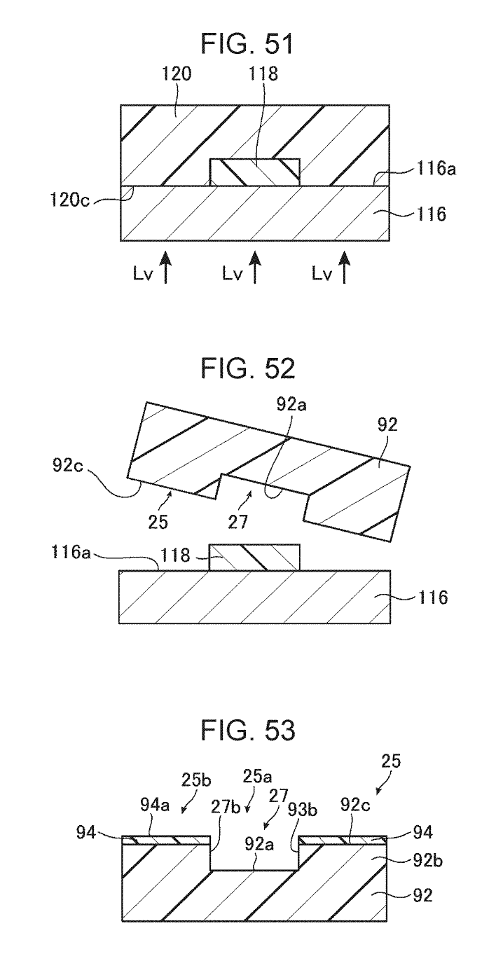

As shown in FIG. 51, the entire surface 120c of the silicone rubber layer 120 is then irradiated with ultraviolet light Lv through the support 116 from the support 116 side. In this case, the region filled with the resist film 118, which becomes the recessed area 27 (see FIG. 8) later, is prevented from being irradiated with the ultraviolet light Lv. The surface 120c of the silicone rubber film 120 becomes the outermost surface 92c of the silicone rubber layer 92.

Since the entire surface 120c is irradiated with the ultraviolet light Lv through the support 116, it is preferred that the support 116 have high transmittance for the ultraviolet light Lv.

The silicone rubber film 120 is then stripped from the support 116. As shown in FIG. 52, the silicone rubber layer 92 is obtained.

The entire outermost surface 92c of the silicone rubber layer 92 is then subjected to silane coupling treatment. Thereafter, as shown in FIG. 53, a fluorine compound layer 94 is formed on the outermost surface 92c subjected to silane coupling treatment, that is, on the surface of the region that becomes the non-image area. The silane coupling treatment and the formation of the fluorine compound layer 94 are performed as described above; therefore, a detailed description thereof is omitted. Thus, a printing plate 25 shown in FIG. 53 can be obtained.

A printing method according to this embodiment will be described next using the printing apparatus 10.

The printing apparatus 10 prints a particular pattern on the substrate 31 based on pattern data about the pattern to be printed.

Information about the positions of the alignment marks A to D is acquired by the alignment camera 42. Information about the attachment position of the printing plate 25 is acquired, and the tilt of the printing plate 25 is determined. If the tilt of the printing plate 25 falls within its acceptable range, inking is performed by ejecting a printing ink from the inkjet head 40 onto the printing plate 25 with a predetermined ejection waveform without tilt correction.

Otherwise, if the tilt of the printing plate 25 falls beyond its acceptable range, tilt correction is performed before the pattern is printed. Thus, even if the attachment accuracy of the printing plate 25 is low, the printing accuracy can be improved by correction for the tilt of the printing plate 25.

After each deposition of droplets of the printing ink, the plate-surface observation unit 26 acquires information about the plate surface 25c of the printing plate 25, and the determination unit 16 makes a determination. Based on the determination result, the control unit 18 adjusts the amount of printing ink ejected and the ejection density before the next deposition of droplets of the printing ink. In this case, if an insufficient amount of printing ink is deposited on the recessed area of the printing plate 25, the volume of droplets of the printing ink is increased at and around the site where an insufficient amount of printing ink is deposited so that larger dots are formed. Alternatively, the droplet density is increased by depositing a number of droplets of the printing ink larger than the predetermined number of droplets.

Conversely, if large dots are formed on the recessed area of the printing plate 25 by the previous deposition of droplets of the printing ink, the volume of droplets of the printing ink is decreased so that smaller dots are formed. Alternatively, the droplet density is decreased by depositing a number of droplets of the printing ink smaller than the predetermined number of droplets.

If the inkjet head 40 has redundant nozzles, the redundant nozzles may also be used.

For example, in the case of pattern data at 2,400 dpi (dots per inch), the application of the printing ink to the pattern-forming region, i.e., inking, can be completed by scanning a pattern at 1,200 dpi in both the X direction and the Y direction four times or by scanning a pattern at 600 dpi in the X direction and 2,400 dpi in the Y direction four times.

For example, in the case of 1,200 dpi in both the X direction and the Y direction, the ejection frequency requirement is low since the distance (minimum distance) between adjacent pixels for each nozzle is 21.2 μm; however, the number of nozzles required is twice that for the case of 600 dpi in the X direction. Since the distance, i.e., the minimum distance, between adjacent pixels in the X direction is 21.2 μm, there is concern about the influence of landing interference in the X direction.

On the other hand, in the case of 600 dpi in the X direction and 2,400 dpi in the Y direction, the number of nozzles is half that for the case of 1,200 dpi in the X direction. The influence of landing interference in the X direction is reduced since the distance, i.e., the minimum distance, between adjacent pixels in the X direction is 42.3 μm; however, the distance, i.e., the minimum distance, between adjacent pixels in the Y direction is 10.6 μm, which requires an ejection frequency that is twice as high as that for the case of 1,200 dpi in both the X direction and the Y direction.

The printing method using the printing apparatus 10 according to this embodiment will be more specifically described next.

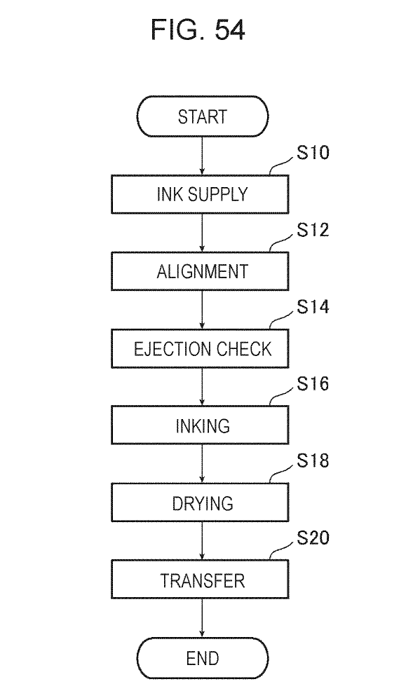

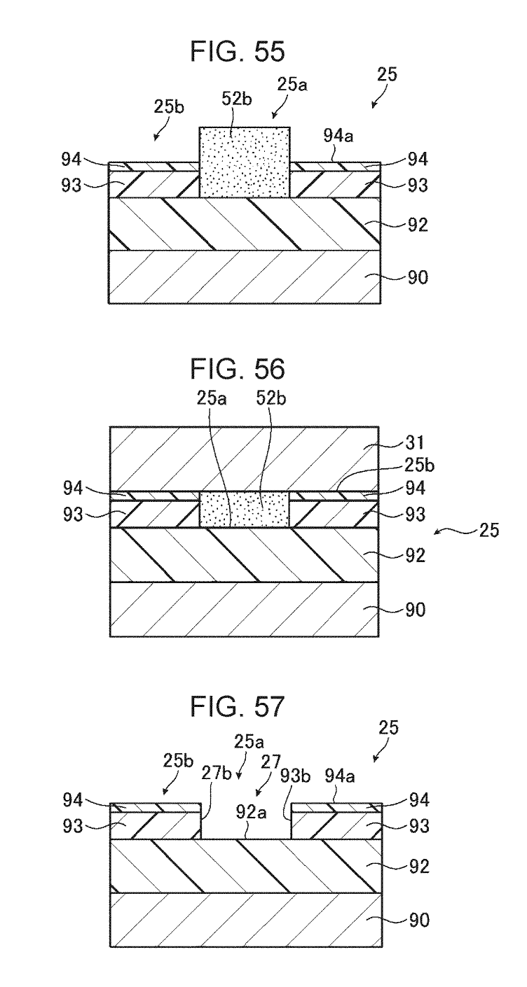

FIG. 54 is a flowchart of the printing method according to the embodiment of the present invention. FIGS. 55 to 58 are schematic sectional views of the steps of the printing method according to the embodiment of the present invention.

A printing ink is first supplied to the ink tank (step S10). In step S10, the printing ink is fed from the ink tank to the subtank and is then supplied from the subtank to the inkjet head 40.

The printing ink is supplied such that a cleaning liquid is replaced with the printing ink. Although the printing ink can also be supplied after the cleaning liquid is purged from the inkjet head 40 with nitrogen gas, the nitrogen gas tends to be entrained. Thus, the printing ink is preferably supplied such that the cleaning liquid is replaced with the printing ink.

An ejection check is performed on the inkjet head 40, which has been supplied with the cleaning liquid. If the result of the ejection check is not good, ejection recovery is attempted using the maintenance unit 36. If recovery is unsuccessful, the inkjet head 40 is replaced if necessary.

To replace the cleaning liquid with the printing ink, for example, the amount of cleaning liquid in the subtank 50 is reduced to the lower limit. The printing ink is then supplied to the subtank 50 to force the cleaning liquid out of the inkjet head 40 with the printing ink. The amount of printing ink in the subtank 50 is then reduced to the lower limit. By repeating the procedure of forcing the cleaning liquid out of the inkjet head 40 with the printing ink and then reducing the amount of printing ink in the subtank 50 to the lower limit, the cleaning liquid is replaced with the printing ink.

Alignment is then performed (step S12).

In this case, the position of the inkjet head 40 is aligned with the plate position. The alignment marks A to C are first read by the alignment camera 42 to detect the positions thereof.

The absolute distance in the X direction is then determined. In this case, for example, the absolute distance in the X direction is calculated from the positions of the carriage 46 (linear scale readings) at which the alignment marks A and B are located at the same position in the X direction in the field of view of the alignment camera 42.

The absolute distance in the Y direction is then determined. In this case, the absolute distance in the Y direction is calculated from information about the rotational positions of the plate cylinder 24 output from the rotary encoder at which the alignment marks A and C are located at the same position in the Y direction in the field of view of the alignment camera 42. It should be noted that the alignment adjustment in the Y direction is performed in terms of angle, rather than distance.

The tilt of the printing plate 25 relative to the inkjet head 40 is then determined. In this case, the tilt angle θ is determined. Not only are the positions of the alignment marks A and B in the X direction determined, but the misalignment in the Y direction is also determined. The misalignment in the Y direction is calculated from information about the rotational positions of the plate cylinder 24 output from the rotary encoder at which the alignment marks A and B are located at the same position in the Y direction in the field of view of the alignment camera 42. The tilt angle β is calculated from the distance in the X direction and the misalignment in the Y direction. The tilt angle β can also be calculated from the misalignment in the Y direction in the field of view of the camera.

Information about the position where the printing plate 25 is attached to the plate cylinder 24 is obtained from the information about the positions of the alignment marks A to C. That is, information about how the printing plate 25 is attached to the plate cylinder 24 is obtained. The tilt angle β of the printing plate 25 is then determined. For example, the tilt angle β can be calculated from the distance in the X direction and the misalignment in the Y direction.

The distance in the X direction, the angle in the Y direction, and the tilt angle θ obtained as described above are stored in the storage unit 14. Based on the distance in the X direction, the angle in the Y direction, and the tilt angle θ, the control unit 18 corrects the pattern data to be printed that is stored in the storage unit 14 by enlargement and reduction in the X direction and the Y direction and the rotation of the pattern data based on the tilt angle θ. The corrected pattern data is optionally subjected to correction for the tilt of the printing plate 25.

Corrected pattern data is obtained. Furthermore, the control unit 18 adjusts the timing when the printing ink is ejected from the inkjet head 40.

An ejection check is then performed on the inkjet head 40 (step S14).

In this case, the ejection check is performed by evaluating a printed test pattern or by observing ejection.

The printed test pattern is evaluated by visual or scanner inspection of the printed substrate. The ejection check can also be performed by ejecting the printing ink onto the printing plate 25 and, without transfer, observing the printing ink on the printing plate 25 with the alignment camera 42.

As described above, the ejection check area T is provided on the printing plate 25, and the printing ink is deposited thereon. Alternatively, the ejection check area T may be provided on the plate cylinder 24, and the printing ink may be deposited thereon.

After evaluation, the printing ink is removed from the ejection check area T by the cleaning unit 34 or is removed by transfer to the substrate 31.

If the result of the ejection check falls beyond a predetermined range, the maintenance unit 36 executes a recovery operation, or the ejection control unit 43 optimizes the ejection waveform.

Along with the ejection check, information about the positions where the droplets of the printing ink have landed on the printing plate 25 is acquired by the alignment camera 42. The determination unit 16 determines landing misalignment. If the distance in the X direction, the angle in the Y direction, or the tilt angle θ falls beyond a predetermined range, adjustments such as enlargement, reduction, and rotation are performed again on the corrected pattern data.

After the ejection check in step S14, the printing plate is inked (step S16).

The pattern data or corrected pattern data is fed to the ejection control unit 43. While the plate cylinder 24 is rotated, inking is performed by ejecting the printing ink from the inkjet head 40 onto the printing plate 25 with a predetermined ejection waveform at the timing based on information about the rotational position of the plate cylinder 24 output from the rotary encoder. For example, the printing ink is applied to the pattern-forming region by rotating the plate cylinder 24 four times, that is, by scanning the plate cylinder 24 four times. In this case, spitting is performed for each scan. Spitting is performed on the spitting areas G of the printing plate 25 or a spitting area (not shown) for spitting provided on the plate cylinder 24.

Spitting may be performed after pattern formation on each printing area or for each printing plate. Alternatively, the maintenance unit 36 may perform purging, wiping, and spitting every certain number of printing plates, for example, every 100 printing plates, and the ejection check may also be performed. Step S16, where the printing plate is inked, corresponds to an ink-applying step. In this case, as shown in FIG. 55, the printing ink 52b is deposited on the image area 25a.

In the inking step, the use of a contactless inking process such as inkjet coating or capillary coating improves the durability of the printing plate 25.

The inked printing plate 25 is then dried with the drying unit 32 (step S18) to dry the printing ink 52b. Step S18 corresponds to a drying step. In step S18, it is desirable that the printing ink be dried to a semi-dry state.

The ink on the printing plate 25 is then transferred to the substrate 31 (step S20).

In the transfer step in step S20, the substrate 31 is first mounted on the stage 30 and stays at the start position Ps. The alignment of the substrate 31 is then performed for the registration of the pattern of the printing plate 25.

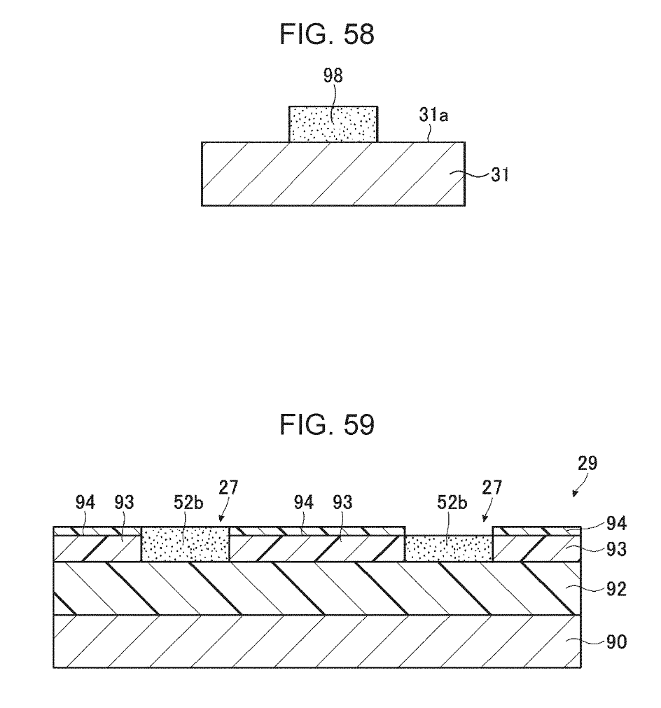

The stage 30 is then moved in the transport direction V to place the substrate 31 at the printing position Pp under the plate cylinder 24. As shown in FIG. 56, the plate cylinder 24 is then rotated to bring the printing plate 25 into contact with the surface 31a of the substrate 31, thereby transferring the printing ink from the printing plate 25 to the substrate 31. After transfer, the stage 30 is moved in the transport direction V to move the printing plate 25 from the printing position Pp under the plate cylinder 24 to the end position Pe. Thereafter, the printing plate 25 having the pattern formed thereon is moved from the stage 30 and is taken out of the casing 20. In this case, as shown in FIG. 57, no printing ink 52b remains on the image area 25a of the printing plate 25. As shown in FIG. 58, the printing ink 52b is transferred to the surface 31a of the substrate 31 to form a pattern area 98.

The image area 25a, that is, the side surface 27b of the recessed area 27, is formed by the silicone rubber layer, whereas the non-image area 25b, that is, the surface of the raised area, is formed by the fluorine compound layer 94. Thus, the printing plate 25 allows little printing ink to overflow from the recessed area 27 and has good printing ink release properties at the side surface 27b of the recessed area 27. This allows the formation of a high-resolution printed pattern. The good printing ink release properties also reduce variations in pattern width and thus allow wiring lines or other components to be formed with uniform characteristics. In addition, a thick pattern can be formed since the thickness of the pattern area 98 corresponds to the height difference δ described above.

Furthermore, as described above, no printing ink remains on the printing plate 25, which eliminates the need for an ink removal step and thus contributes to more efficient use of the ink.

In addition, the thickness of the pattern area 98 can be changed by changing the amount of printing ink 52b applied to the image area 25a, that is, the recessed area 27.

Here, FIGS. 59 to 61 are schematic sectional views showing the steps of another example printing method according to the embodiment of the present invention. In FIGS. 59 to 61, components identical to those of the printing plate 25 shown in FIG. 7 are denoted by the same reference numerals, and a detailed description thereof is omitted.

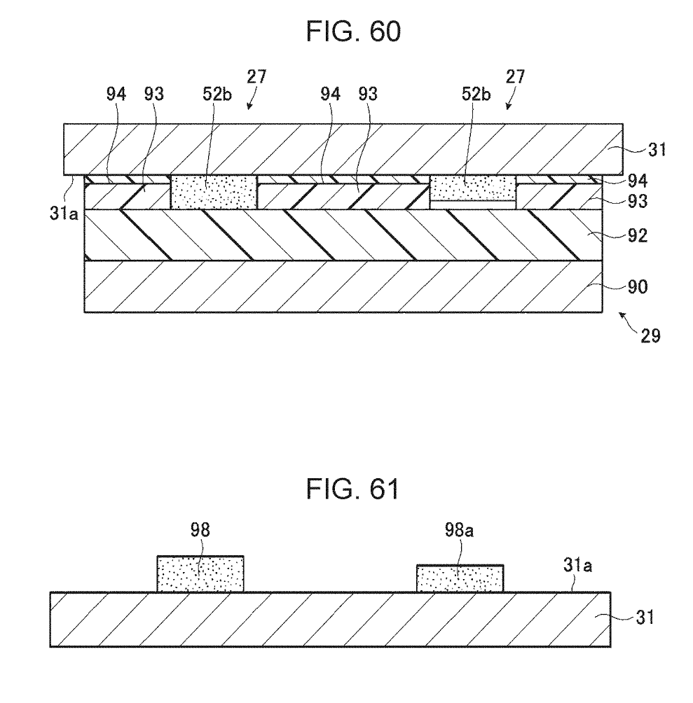

If the printing plate 25 has a plurality of recessed areas 27 serving as the image area 25a, for example, two recessed areas 27, as does a printing plate 29 shown in FIG. 59, the amount of printing ink 52b applied to each recessed area 27 is changed by changing the amount of printing ink 52b ejected by an inkjet process. As shown in FIG. 60, the printing plate 29 is brought into contact with a surface 31a of a substrate 31 to transfer the printing ink from the printing plate 29 to the substrate 31. Thus, as shown in FIG. 61, pattern areas 98 and 98a with different thicknesses can be formed on the surface 31a of the substrate 31 by a single transfer step. This allows wiring lines with different thicknesses to be simultaneously formed. In this case, variations in the pattern width of the pattern areas 98 and 98a can be reduced, which allows wiring lines or other components to be formed with uniform characteristics.

Although a sheet-fed process in which the printing plate 25 is in sheet form has been described, the printing plate 25 need not be in sheet form, but may instead be in roll form. In this case, a pattern can be formed by a roll-to-sheet process, a sheet-to-roll process, or a roll-to-roll process.

The printing ink may be any printing ink that is not repelled by the image area 25a. It is desirable that the printing ink have a surface tension lower than or equal to the critical surface free energy of silicone rubber.

There are characteristics that are limited by the combination of the substrate and the printing ink, namely, advancing contact angle, receding contact angle, and absorption rate. The printing ink need not have a surface tension lower than or equal to the critical surface free energy of silicone rubber as long as the advancing contact angle, receding contact angle, and absorption rate conditions are satisfied.

In addition, the printing ink is preferably a Newtonian fluid. The printing ink preferably has a viscosity of from 1 mPa·s to 20 mPa·s. This viscosity, however, need not necessarily be satisfied if the rate of absorption vₛ of the solvent from the printing ink into the image area 25a is so high that the printing ink dries quickly upon application and therefore the formation of liquid-repellent nuclei is inhibited.

Materials for printing inks used for the formation of wiring lines and components of electronic elements such as thin-film transistors for electronic circuits and precursors of wiring lines and components of electronic elements such as thin-film transistors for electronic circuits will now be specifically described.

A preferred conductive material contains fine conductive particles having a particle size of from 1 nm to 100 nm. The use of fine conductive particles having a particle size of more than 100 nm tends to cause nozzle clogging, which makes it difficult to eject the ink by an inkjet process. The use of fine conductive particles having a particle size of less than 1 nm results in a large volume ratio of the coating agent to the fine conductive particles and therefore results in an excessive proportion of organic material in the resulting film.

From the standpoint of dispersoid aggregation, the preferred dispersoid concentration is from 1% by mass to 80% by mass.

A preferred liquid dispersion of fine conductive particles has a surface tension in the range from 20 mN/m to 70 mN/m. A surface tension of less than 20 mN/m tends to cause the liquid to deflect when ejected by an inkjet process because of the increased wettability of the printing ink composition on the nozzle surface. A surface tension of more than 70 mN/m makes it difficult to control the amount of ink ejected and the ejection timing because of the unstable meniscus shape at nozzle tips.

An example conductive material contains fine silver particles. Examples of other fine metal particles include gold, platinum, copper, palladium, rhodium, osmium, ruthenium, iridium, iron, tin, zinc, cobalt, nickel, chromium, titanium, tantalum, tungsten, and indium, which may be used alone or as an alloy of any combination thereof. Silver halides may also be used. Nevertheless, silver nanoparticles are preferred. Fine particles other than fine metal particles, such as conductive polymer and superconductor fine particles, may also be used.

Examples of coating materials for coating the surface of the fine conductive particles include organic solvents such as xylene and toluene and citric acid.

The dispersion medium may be any dispersion medium that satisfies the characteristics limited by the combination of the substrate and the printing ink, namely, advancing contact angle, receding contact angle, and solvent absorption rate, and that allows the fine conductive particles to be dispersed therein without aggregation. Examples of dispersion media include water; alcohols such as methanol, ethanol, propanol, and butanol; hydrocarbon compounds such as n-heptane, n-octane, decane, tetradecane, toluene, xylene, cymene, durene, indene, dipentene, tetrahydronaphthalene, decahydronaphthalene, and cyclohexylbenzene; ether compounds such as ethylene glycol dimethyl ether, ethylene glycol diethyl ether, ethylene glycol methyl ethyl ether, diethylene glycol dimethyl ether, diethylene glycol diethyl ether, diethylene glycol methyl ethyl ether, 1,2-dimethoxyethane, bis(2-methoxyethyl) ether, and p-dioxane; and polar compounds such as propylene carbonate, γ-butyrolactone, N-methyl-2-pyrrolidone, dimethylformamide, dimethyl sulfoxide, and cyclohexanone. Of these, water, alcohols, hydrocarbon compounds, and ether compounds are preferred from the standpoint of the dispersibility of the fine particles, the stability of the liquid dispersion, and the ease of application to inkjet processes. More preferred dispersion media are water and hydrocarbon compounds. These dispersion media can be used alone or in mixture.

Examples of binders, that is, additives, that can be used alone or in combination include alkyd resins, modified alkyd resins, modified epoxy resins, urethanated oils, urethane resins, rosin resins, rosinated oils, maleic acid resins, maleic anhydride resins, polybutene resins, diallyl phthalate resins, polyester resins, polyester oligomers, mineral oils, vegetable oils, urethane oligomers, and (meth)allyl ether-maleic anhydride copolymers. Copolymers of maleic anhydride may contain other monomers such as styrene as comonomers.

Examples of additives that may be selected and added to the metal paste as appropriate include dispersing agents, wetting agents, thickeners, leveling agents, antiscumming agents, gelling agents, silicone oils, silicone resins, anti-foaming agents, and plasticizers.

Solvents that can be used include normal paraffin, isoparaffin, naphthene, and alkylbenzenes.

Conductive organic materials can also be used. For example, polymeric soluble materials such as polyaniline, polythiophene, and polyphenylene vinylene may be contained.

Instead of fine metal particles, organometallic compounds may be contained. As used herein, “organometallic compound” refers to a compound that is decomposed by heating to precipitate a metal. Examples of such organometallic compounds include chlorotriethylphosphinegold, chlorotrimethylphosphinegold, chlorotriphenylphosphinegold, silver 2,4-pentanedionate complexes, trimethylphosphine(hexafluoroacetylacetonato)silver complexes, and copper hexafluoropentanedionate cyclooctadiene complexes.

Other examples of fine conductive particles include resists, acrylic resins serving as linear insulating materials, silane compounds that form silicone when heated, and metal complexes. These may be dispersed in a liquid as fine particles or may be dissolved therein. Examples of silane compounds that form silicone when heated include trisilane, pentasilane, cyclotrisilane, and 1,1′-biscyclobutasilane.

Examples of liquids containing conductive organic materials include aqueous solutions of polyethylenedioxythiophene (PEDOT) and polystyrenesulfonic acid (PPS), which are conductive polymers; doped polyaniline (PANT); and aqueous solutions of conductive polymers obtained by doping polyethylenedioxythiophene (PEDOT) with polystyrenesulfonic acid (PSS).

Examples of materials that can be used to form semiconductor layers include inorganic semiconductors such as CdSe, CdTe, GaAs, InP, Si, Ge, carbon nanotubes, and ZnO and organic semiconductors such as low-molecular-weight organic compounds such as pentacene, anthracene, tetracene, and phthalocyanine; polyacetylene-based conductive polymers; polyphenylene-based conductive polymers such as polyparaphenylene and derivatives thereof and polyphenylene vinylene and derivatives thereat heterocyclic conductive polymers such as polypyrrole and derivatives thereof, polythiophene and derivatives thereof, and polyfuran and derivatives thereof; and ionic conductive polymers such as polyaniline and derivatives thereof.

Materials with good electrical insulation properties, that is, insulating materials, that can be used to form interlayer insulating films include the following materials. Specifically, examples of organic materials include polyimides, polyamide-imides, epoxy resins, silsesquioxanes, polyvinylphenol, polycarbonates, fluorocarbon resins, polyparaxylylene, and polyvinyl butyral. Polyvinylphenol and polyvinyl alcohol may be crosslinked with suitable crosslinking agents before use. Specific examples include fluorinated polymers such as polyxylene fluoride, fluorinated polyimides, fluorinated polyaryl ethers, polytetrafluoroethylene, polychlorotrifluoroethylene, poly(α,α,α′,α′-tetrafluoro-paraxylene)), polyethylene-polytetrafluoroethylene, polyethylene-polychlorotrifluoroethylene, and fluorinated ethylene-propylene copolymers; polyolefinic polymers; and other polymers such as polystyrene, poly(α-methylstyrene), poly(α-vinylnaphthalene), polyvinyltoluene, polybutadiene, polyisoprene, poly(4-methyl-1-pentene), poly(2-methyl-1,3-butadiene), polyparaxylene, poly[1,1-(2-methylpropane) bis(4-phenyl)carbonate], polycyclohexyl methacrylate, polychlorostyrene, poly(2,6-dimethyl-1,4-phenylene ether), polyvinylcyclohexane, polyarylene ethers, polyphenylene, polystyrene-co-α-methylstyrene, ethylene-ethyl acrylate copolymers, and poly-2,4-dimethylstyrene.

Examples of porous insulating films include phosphosilicate glass, which is phosphorus-doped silicon dioxide, borophosphosilicate glass, which is phosphorus- and boron-doped silicon dioxide, polyimides, and polyacrylics. Porous insulating films having siloxane bonds, such as porous methylsilsesquioxane, porous hydrosilsesquioxane, and porous methylhydrosilsesquioxane, can also be formed.

The materials contained in the printing ink are not limited to those mentioned above; rather, suitable materials may be selected depending on the application. For example, printing inks such as those containing colorants used for the manufacture of color filters can also be used. Examples of colorants include known dyes and pigments. Such printing inks may contain dispersion media and binders as mentioned above.

The present invention is basically configured as described above. Although printing methods and printing apparatuses according to the invention have been described above in detail, the invention is not limited to the foregoing embodiment; it should be understood that various improvements and modifications may be made without departing from the spirit of the invention.

### Example 1

The features of the present invention will now be more specifically described with reference to the following examples. The materials, reagents, amounts used, amounts of substance, proportions, processes, process sequences, and other details given in the following examples can be changed as appropriate without departing from the spirit of the invention. Thus, the specific examples given below should not be construed as limiting the scope of the invention.

### Example 1

A pigment ink having silver nanoparticles dispersed therein (silver nanoparticle ink available from ULVAC, Inc.) was used as a conductive ink. A thermosetting silicone rubber available from Shin-Etsu Chemical Co., Ltd. was used as a silicone rubber layer. Durasurf (DS-5210TH (product name)) available from Harves Co., Ltd. was used as a fluorine compound. A primer (DS-PC-3B (product name)) available from Harves Co., Ltd. was used as a primer solution. Three silicon wafers having raised patterns with a depth of 1 μm and widths of 10 μm, 20 μm, and 50 μm were used as templates.

The uncured silicone rubber was poured onto each template, was held between the template and a support 90, and was cured by heating in an oven at a temperature of 150° C. for 30 minutes. Thereafter, the silicone rubber was released from the template to form a recessed silicone rubber layer 92 (see FIG. 8). A flat sheet of silicone rubber (substrate 112) was immersed in the primer solution for three days so that the low-molecular-weight components present in the primer solution were absorbed into the silicone rubber. After immersion, the wet sheet was spun on a spin coater to remove residual primer solution from the surface of the sheet (substrate 112).

The surface of the silicone rubber layer 92 was subjected to activation treatment by irradiation with ultraviolet light using as a light source a VUS-3150 available from Ore Manufacturing Co., Ltd., which was equipped with an excimer lamp, in a nitrogen atmosphere with an oxygen concentration of less than 1% for 15 seconds.

Thereafter, the sheet (substrate 112) was placed in contact with the intaglio plate at room temperature for 30 minutes to complete silane coupling treatment. Thereafter, the silane coupling agent was fixed on a hot plate at a temperature of 120° C. in a saturated water vapor pressure environment for 30 minutes. Durasurf (DS-5210TH (product name)) available from Harves Co., Ltd., serving as a fluorine compound, was then applied to the silicone rubber layer after silane coupling treatment on a spin coater, and the fluorine compound was fixed on a hot plate at a temperature of 120° C. for 20 minutes to form a fluorine compound layer 94. Finally, any unfixed fluorine compound was removed by spin coating with a fluorinated solvent (Durasurf (DS-TH (product name)) available from Harves Co., Ltd.) to obtain an intaglio plate. Printing plates 25 were thus obtained.

### Evaluation of Example 1

The printing plates 25 were subjected to a printing test on a polycarbonate film by inking with the pigment ink having silver nanoparticles dispersed therein using an inkjet apparatus (available from Dimatix, Inc., 10 pL (picoliter) head). In addition, the printing plates 25 were subjected to a printing test on a polycarbonate film by inking with the pigment ink having silver nanoparticles dispersed therein by blade coating.

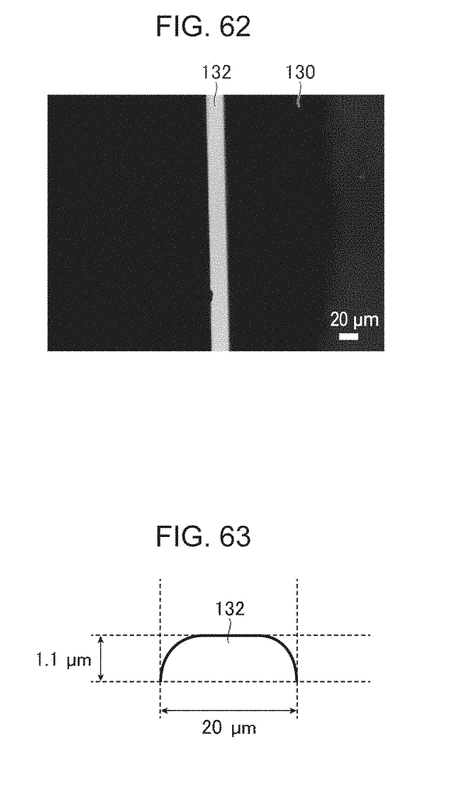

When inkjet droplets were ejected onto the printing plate having a line-and-space pattern with a recess size of 20 μm such that the landing diameter was 26 μm, the inkjet droplets were well repelled by the raised area (non-image area 25b) to form an ink film on the line pattern formed by the recessed area (image area 25a) of the printing plate. This ink film was transferred to a polycarbonate film. As shown in FIG. 62, a wiring line 132 with a width of 20 μm was successfully formed on the polycarbonate film 130. The cross-sectional profile of the wiring line 132 was also examined under a confocal laser microscope. As shown in FIG. 63, the wiring line 132 had a height of 1.1 μm, demonstrating that its cross-section had high rectangularity.

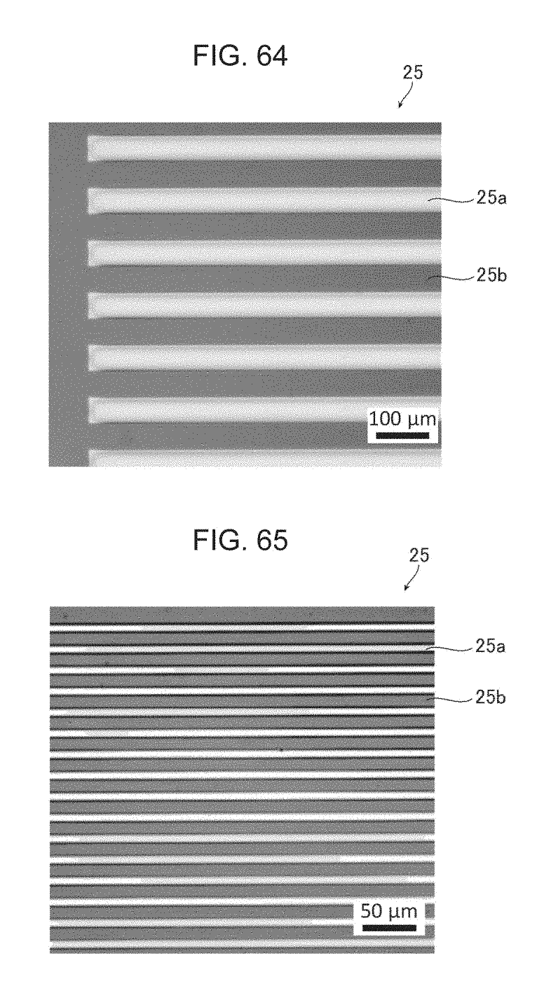

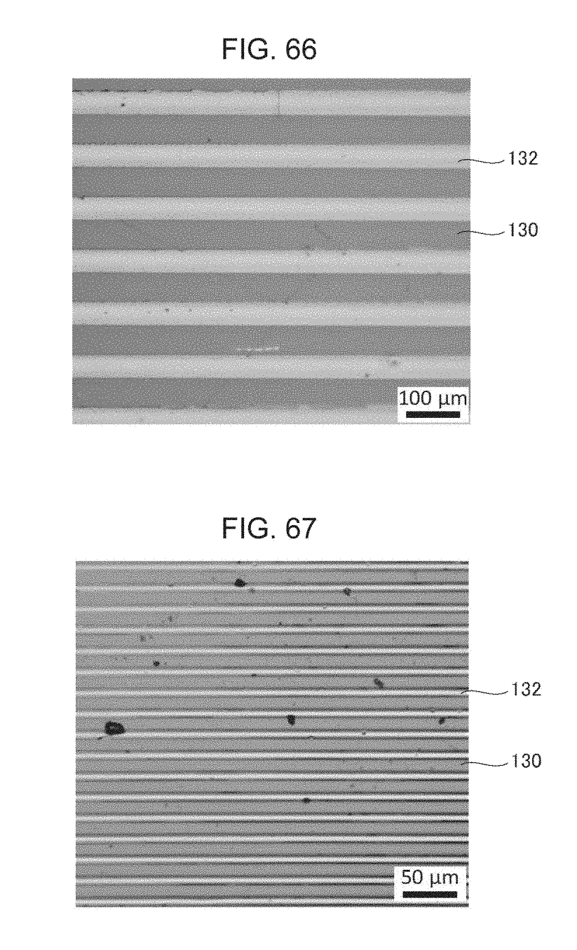

The entire surfaces of the printing plates of Example 1 were inked by blade coating. As can be seen from the first inking result in FIG. 64 and the second inking result in FIG. 65, the raised areas (non-image areas 25b) of the printing plates 25 repelled the printing ink 52b, and only the recessed areas (image areas 25a) of the printing plates 25 were filled with the printing ink 52b. The printing plate 25 in FIG. 64 corresponds to the pattern with a width of 50 μm, whereas the printing plate 25 in FIG. 65 corresponds to the pattern with a width of 10 μm. Furthermore, the ink was transferred from each printing plate 25 to a polycarbonate film. As shown in FIG. 66, wiring lines 132 with a width of 50 μm were successfully formed on the polycarbonate film 130. As shown in FIG. 67, wiring lines 132 with a width of 10 μm were successfully formed on the polycarbonate film 130. Thus, good printed wiring lines were obtained.

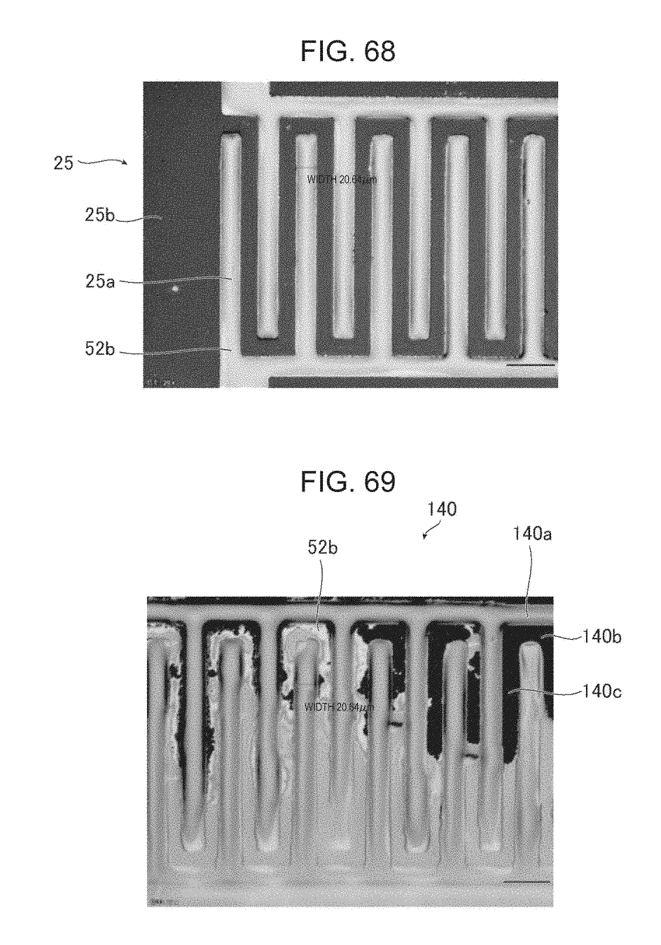

In addition, the entire surface of a printing plate 25 having a comb-shaped pattern with a width of 20 μm was inked by blade coating. As can be seen from the third inking result in FIG. 68, the raised area (non-image area 25b) of the printing plate 25 exhibited good liquid repellency, and only the recessed area (image area 25a) of the printing plate was filled with the printing ink 52b.

### Comparative Example 1

For comparison with Example 1, as in Example 1, the uncured silicone rubber was poured onto a template, was held between the template and a support 90, and was cured by heating in an oven at a temperature of 150° C. for 30 minutes to obtain a recessed silicone rubber layer 92 (see FIG. 8). The recessed silicone rubber layer 92 was inked by applying the same printing ink as in Example 1 to the same recessed pattern as in FIG. 68 by blade coating. The inking result is shown in FIG. 69. As shown in FIG. 69, the printing plate 140 of Comparative Example 1 had no fluorine compound layer formed on the surface 140c of the raised area 140b, and the printing ink 52b was applied substantially over the entire surface of the printing plate 140, including both the raised area 140b and the recessed area 140a. It was found that the purpose of filling only the recessed area 140a with the printing ink cannot be achieved.

### Example 2

In this example, five samples, namely, Samples 1 to 5, were fabricated in the same manner as the printing plates of Example 1 above as follows.

Specifically, a silicone rubber layer cured by heating was subjected to activation treatment by irradiation with ultraviolet light using as a light source a VUS-3150 available from Ore Manufacturing Co., Ltd., which was equipped with an excimer lamp, in a nitrogen atmosphere with an oxygen concentration of less than 1% for 10 seconds.

Thereafter, a primer intended for Durasurf (DS-PC-3B (model No.)), serving as a silane coupling agent, was used to complete silane coupling treatment. Thereafter, any unreacted silane coupling agent was removed by spinning on a spin coater. Thereafter, five different levels of the fixing condition of the silane coupling agent were tested by changing the heating temperature and other heating conditions. Durasurf (DS-5210TH (product name)) available from Harves Co., Ltd., serving as a fluorine compound, was then applied to the silicone rubber layer after silane coupling treatment on a spin coater, and the fluorine compound was fixed on a hot plate at a temperature of 120° C. for 20 minutes. Finally, any unfixed fluorine compound was removed by spin coating with a fluorinated solvent (Durasurf (DS-TH (product name)) available from Harves Co., Ltd.) to obtain five samples having ink-repellent areas that differed in liquid repellency, namely, Samples 1 to 5.

The surface structure of Samples 1 to 5 thus fabricated was analyzed by time-of-flight secondary ion mass spectrometry (TOF-SIMS). The PDMS coverage of the fluorine compound was evaluated from the ratio of the amount of fluorine compound to the amount of PDMS component.

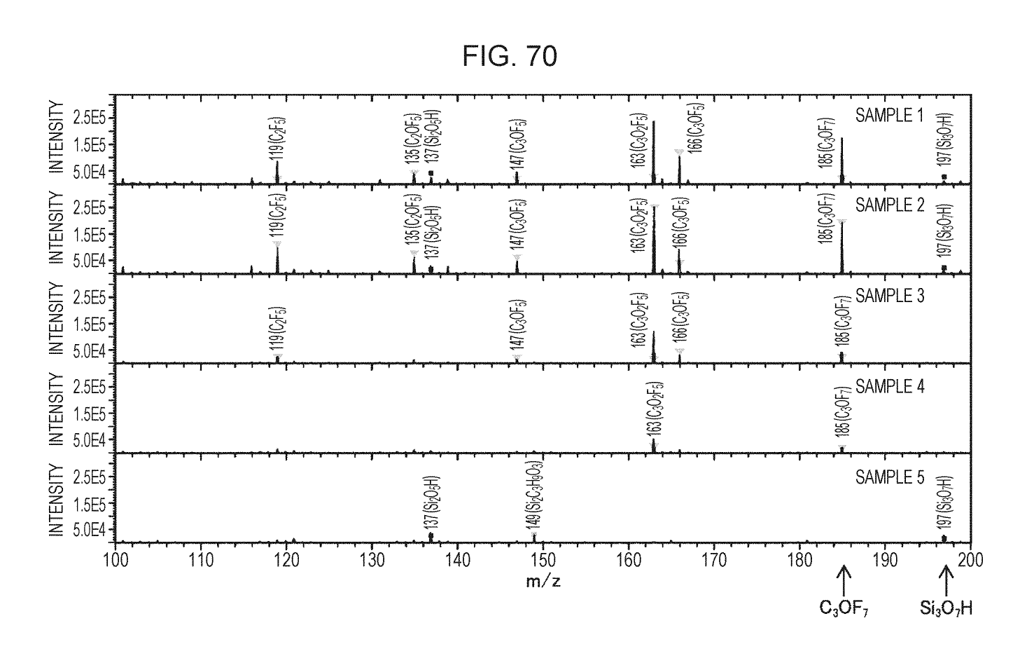

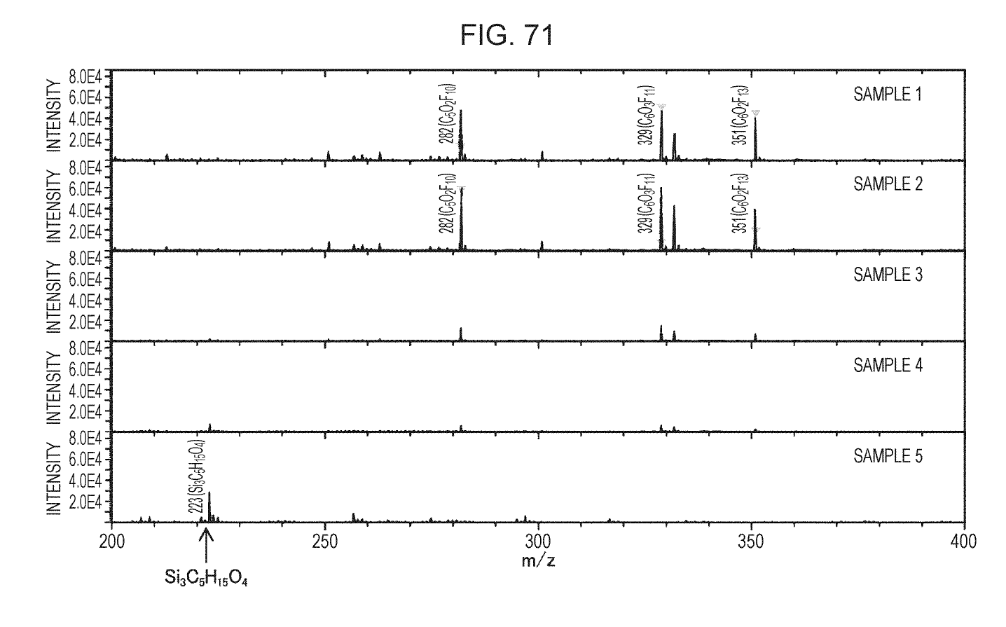

A TOF.SIMS 300 available from ION-TOF GmbH was used for measurement. The measurement was performed in a high-mass-resolution mode using Bi as a primary ion source. Negative secondary ions were detected under the following conditions: beam diameter, 2 to 5 μm; dose, 1.3×10¹⁰ ions/cm²; measurement range, 500 μm; number of steps in measurement range, 128×128. The qualitative spectra obtained from Samples 1 to 5 by the TOF-SIMS measurement are shown in FIGS. 70 and 71.

As described above, the PDMS coverage of the fluorine compound was estimated by calculating the ratio of the amount of fluorine compound to the amount of PDMS-derived component determined by TOF-SIMS by the following equation. The results of the F/Si ratios of Samples 1 to 5 are shown in Table 1 below.

F/Si ratio=[C₃OF₇]/([Si₃O₇H]+[Si₃C₅H₁₅O₄])

In this equation, [C₃OF₇], [Si₃O₇H], and [Si₃C₅H₁₅O₄] are as defined above; therefore, a description thereof is omitted.

The receding contact angles θ_{R,f} of Samples 1 to 5 were measured. The results of the receding contact angle θ_{R,f} are shown in Table 1 below. As a result, the F/Si ratio of Sample 1 was 0.38, and the receding contact angle θ_{R,f} of Sample 1 was 0°. In contrast, the F/Si ratio of Sample 5 was 1946.75, and the receding contact angle θ_{R,f} of Sample 5 was 43°.

Samples 1 to 5 were also subjected to an inking test as in Example 1 above. Samples on which the printing ink did not remain on the ink-repellent area but flowed to the ink-receptive area were determined to have good liquid repellency, whereas samples on which the printing ink remained on the ink-repellent area were determined to have poor liquid repellency.

For Samples 2 to 4, which were treated in a manner between the treatment of Sample 1 and the treatment of Sample 5, there was a positive correlation among F/Si ratio, receding contact angle θ_{R,f}, and liquid repellency. It was found that a F/Si ratio of 1689.75 or more is sufficient to achieve a large receding contact angle θ_{R,f}.

TABLE 1

| | F/Si ratio | Receding contact angle θ_{R, f} | Liquid repellency |
|---|---|---|---|
| Sample 1 | 0.38 | 0° | Poor |
| Sample 2 | 198.42 | 13° | Poor |
| Sample 3 | 986.73 | 15° | Poor |
| Sample 4 | 1689.75 | 45° | Good |
| Sample 5 | 1946.75 | 43° | Good |

### REFERENCE SIGNS LIST

10 printing apparatus
12 printing apparatus body
14 storage unit
16 determination unit
18 control unit
20 casing
20a interior
22 image-recording unit
24 plate cylinder
24a surface
24b rotating shaft
25, 29, 140 printing plate
25a image area
25b non-image area
25c plate surface
26 plate-surface observation unit
27 recessed area
27b, 93b side surface
30 stage
31 substrate
31a surface
32 drying unit
33 ionizer
34 cleaning unit
36 maintenance unit
39 transfer unit
40 inkjet head
40a head module
41 nozzle
42 alignment camera
43 ejection control unit
44 laser displacement meter
45 ink droplet
46 carriage
48 linear motor
49 rotating unit
50, 58 subtank
50a, 58a liquid level sensor
50b, 54a temperature control unit
50c, 58c, 60c, 62b, 62f, 64c, 64d pipe
51 degassing unit
52 ink tank
52a, 58b temperature control unit
52b printing ink
54 cleaning liquid bottle
54b cleaning liquid
56 waste liquid tank
60 circulating unit
60a, 62a pump
60b, 62e filter
62c cylinder
64a pump
64b pressure sensor
80 thin-film transistor
82 gate electrode
84 channel region
86a source electrode
86b drain electrode
90 support
92, 93, 97 silicone rubber layer
92a, 93a, 94a, 97c surface
92c outermost surface
93c recessed area
94, 95, 102 fluorine compound layer
98 pattern area
100 silicone rubber layer
100a irradiated region
100b unirradiated region
100c surface
102a irradiated region
102b unirradiated region
102c surface
110, 122 mask
110a, 122a chromium layer
110b, 122b region
112 substrate
114, 115 resist layer
116 support
116a surface
118 resist film
120 silicone rubber film
122 mask
130 polycarbonate film
132 wiring line
140a recessed area
140b raised area
140c surface
A, B, C, D alignment mark
G spitting area
G₁₁, G₁₂, G₂₁, G₂₂, G₃₁, G₃₂ printing area
Lv ultraviolet light
Le laser light
Pe end position
Pp printing position
Ps start position
T ejection check area
V transport direction
δ height difference
θ tilt angle

What is claimed is:

1. A printing plate comprising an image area and a non-image area, wherein
the image area is a recessed area formed by a layer containing silicone rubber,
the non-image area is a raised area formed by a layer containing a fluorine compound on a surface of the layer containing silicone rubber, and
a height difference between a surface of the image area and a surface of the non-image area is from more than 0.1 μm to 10 μm.

2. The printing plate according to claim 1, wherein a receding contact angle of a printing ink on the non-image area is larger than an advancing contact angle of the printing ink on the image area.

3. The printing plate according to claim 1, wherein a printing ink contains a solvent, and a rate of absorption of the solvent into the image area is higher than a rate of absorption of the solvent into the non-image area.

4. The printing plate according to claim 2, wherein a printing ink contains a solvent, and a rate of absorption of the solvent into the image area is higher than a rate of absorption of the solvent into the non-image area.

5. The printing plate according to claim 2, wherein the printing ink has a viscosity of from 1 mPa·s to 30 mPa·s.

6. The printing plate according to claim 3, wherein the printing ink has a viscosity of from 1 mPa·s to 30 mPa·s.

7. The printing plate according to claim 1, wherein the printing plate is used for manufacture of an electronic device.

8. The printing plate according to claim 2, wherein the printing plate is used for manufacture of an electronic device.

9. The printing plate according to claim 1, wherein the printing plate is used for formation of a wiring pattern or an electrode.

10. The printing plate according to claim 2, wherein the printing plate is used for formation of a wiring pattern or an electrode.

11. A printing method using a printing plate having an image area and a non-image area,
wherein the image area is a recessed area formed by a layer containing silicone rubber, the non-image area is a raised area formed by a layer containing a fluorine compound on a surface of the layer containing silicone rubber, and a height difference between a surface of the image area and a surface of the non-image area is from more than 0.1 μm to 10 μm,
the printing method comprising:
an ink-applying step of applying a printing ink to the image area; and
a transfer step of transferring the printing ink from the image area to a substrate.

12. The printing method according to claim 11, wherein the ink-applying step includes applying the printing ink to the image area by an inkjet process.

13. The printing method according to claim 11, wherein the ink-applying step includes changing an amount of printing ink applied to the image area.

14. The printing method according to claim 12, wherein the ink-applying step includes changing an amount of printing ink applied to the image area.

15. A method for manufacturing a printing plate having an image area and a non-image area, wherein the image area is a recessed area formed by a layer containing silicone rubber, the non-image area is a raised area formed by a layer containing a fluorine compound on a surface of the layer containing silicone rubber, and a height difference between a surface of the image area and a surface of the non-image area is from more than 0.1 μm to 10 μm, the method comprising the steps of:
forming a second layer containing silicone rubber in a region that becomes the non-image area on a first layer containing silicone rubber to obtain the layer containing silicone rubber; and
forming the layer containing the fluorine compound on a surface of the second layer containing silicone rubber.

16. A method for manufacturing a printing plate having an image area and a non-image area, wherein the image area is a recessed area formed by a layer containing silicone rubber, the non-image area is a raised area formed by a layer containing a fluorine compound on a surface of the layer containing silicone rubber, and a height difference between a surface of the image area and a surface of the non-image area is from more than 0.1 μm to 10 μm, the method comprising the steps of:
forming the layer containing the fluorine compound on the layer containing silicone rubber; and
removing the layer containing the fluorine compound and the layer containing silicone rubber from a region that becomes the image area.

17. A method for manufacturing a printing plate having an image area and a non-image area, wherein the image area is a recessed area formed by a layer containing silicone rubber, the non-image area is a raised area formed by a layer containing a fluorine compound on a surface of the layer containing silicone rubber, and a height difference between a surface of the image area and a surface of the non-image area is from more than 0.1 μm to 10 μm, the method comprising the steps of:
forming a layer containing a fluorosurfactant and a silicone resin on the layer containing silicone rubber; and
removing the layer containing the fluorosurfactant and the silicone resin from a region that becomes the image area.

18. A method for manufacturing a printing plate having an image area and a non-image area, wherein the image area is a recessed area formed by a layer containing silicone rubber, the non-image area is a raised area formed by a layer containing a fluorine compound on a surface of the layer containing silicone rubber, and a height difference between a surface of the image area and a surface of the non-image area is from more than 0.1 μm to 10 μm, the method comprising the steps of:
forming the layer containing silicone rubber on a support having a raised pattern for forming the recessed area of the printing plate;
stripping the layer containing silicone rubber from the support; and
forming the layer containing the fluorine compound on a surface of a region of the layer containing silicone rubber, the region being a region that becomes the non-image area.
